(19) United States
(12) Patent Application Publication
(10) Pub. No.: US 2018/0357038 A1
(43) Pub. Date: Dec. 13, 2018

(54) AUDIO METADATA MODIFICATION AT RENDERING DEVICE

(71) Applicant: QUALCOMM Incorporated, San Diego, CA (US)

(72) Inventors: Ferdinando Olivieri, San Diego, CA (US); Jason Filos, San Diego, CA (US); Shankar Thagadur Shivappa, San Diego, CA (US); Dipanjan Sen, San Diego, CA (US)

(21) Appl. No.: 15/619,026

(22) Filed: Jun. 9, 2017

(51) Int. Cl. G06F 3/16; G06F 3/01; G10L 19/008; H04S 7/00

(52) U.S. Cl. CPC G06F 3/165; G06F 3/162; G06F 3/167; H04S 2420/11; G10L 19/008; H04S 7/303; G06F 3/017

(57) ABSTRACT

An apparatus includes a network interface configure to receive an audio bitstream. The audio bitstream includes encoded audio associated with one or more audio objects and audio metadata indicating one or more sound attributes of the one or more audio objects. The apparatus also includes a memory configured to store the encoded audio and the audio metadata. The apparatus further includes a controller configured to receive an indication to adjust a particular sound attribute of the one or more sound attributes. The particular sound attribute is associated with a particular audio object of the one or more audio objects. The controller is also configured to modify the audio metadata, based on the indication, to generate modified audio metadata.

### I. FIELD

The present disclosure is generally related to audio rendering.

### II. DESCRIPTION OF RELATED ART

Advances in technology have resulted in smaller and more powerful computing devices. For example, a variety of portable personal computing devices, including wireless telephones such as mobile and smart phones, tablets and laptop computers are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing and networking capabilities.

A content provider may provide encoded multimedia streams to a decoder of a user device. For example, the content provider may provide encoded audio streams and encoded video streams to the decoder of the user device. The decoder may decode the encoded multimedia streams to generate decoded video and decoded audio. A multimedia renderer may render the decoded video to generate rendered video, and the multimedia renderer may render the decoded audio to generate rendered audio. The rendered audio may be projected (e.g., output) using an output audio device. For example, the rendered audio may be projected using speakers, sound bars, headphones, etc. The rendered video may be displayed using a display device. For example, the rendered video may be displayed using a television, a monitor, a mobile device screen, etc.

However, the rendered audio and the rendered video may be sub-optimal based on user preferences, user location, or both. As a non-limiting example, a user of the user device may move to a location where a listening experience associated with the rendered audio is sub-optimal, a viewing experience associated with the rendered video is sub-optimal, or both. Further, the user device may not provide the user with the capability to adjust the audio to the user's preference via an intuitive interface, such as by modifying the location and audio level of individual sound sources within the rendered audio. As a result, the user may have a reduced user experience.

### SUMMARY

According to one implementation of the present disclosure, an apparatus includes a network interface configured to receive a media stream from an encoder. The media stream includes encoded audio and metadata associated with the encoded audio. The metadata is usable to determine three-dimensional audio rendering information for different portions of the encoded audio. The apparatus also includes an audio decoder configured to decode the encoded audio to generate decoded audio. The audio decoder is also configured to detect a sensor input and modify the metadata based on the sensor input to generate modified metadata. The apparatus further includes an audio renderer configured to render the decoded audio based on the modified metadata to generate rendered audio having three-dimensional sound attributes. The apparatus also includes an output device configured to output the rendered audio.

According to another implementation of the present disclosure, a method of rendering audio includes receiving a media stream from an encoder. The media stream includes encoded audio and metadata associated with the encoded audio. The metadata is usable to determine three-dimensional audio rendering information for different portions of the encoded audio. The method also includes decoding the encoded audio to generate decoded audio. The method further includes detecting a sensor input and modifying the metadata based on the sensor input to generate modified metadata. The method also includes rendering the decoded audio based on the modified metadata to generate rendered audio having three-dimensional sound attributes. The method also includes outputting the rendered audio.

According to another implementation of the present disclosure, a non-transitory computer-readable medium includes instructions for rendering audio. The instructions, when executed by a processor within a rendering device, cause the processor to perform operations including receiving a media stream from an encoder. The media stream includes encoded audio and metadata associated with the encoded audio. The metadata is usable to determine three-dimensional audio rendering information for different portions of the encoded audio. The operations also include decoding the encoded audio to generate decoded audio. The operations further include detecting a sensor input and modifying the metadata based on the sensor input to generate modified metadata. The operations also include rendering the decoded audio based on the modified metadata to generate rendered audio having three-dimensional sound attributes. The operations also include outputting the rendered audio.

According to another implementation of the present disclosure, an apparatus includes means for receiving a media stream from an encoder. The media stream includes encoded audio and metadata associated with the encoded audio. The metadata is usable to determine three-dimensional audio rendering information for different portions of the encoded audio. The apparatus also includes means for decoding the encoded audio to generate decoded audio. The apparatus further includes means for detecting a sensor input and means for modifying the metadata based on the sensor input to generate modified metadata. The apparatus also includes means for rendering the decoded audio based on the modified metadata to generate rendered audio having three-dimensional sound attributes. The apparatus also includes means for outputting the rendered audio.

According to another implementation of the present disclosure, an apparatus includes a network interface configure to receive an audio bitstream. The audio bitstream includes encoded audio associated with one or more audio objects and audio metadata indicating one or more sound attributes of the one or more audio objects. The apparatus also includes a memory configured to store the encoded audio and the audio metadata. The apparatus further includes a controller configured to receive an indication to adjust a particular sound attribute of the one or more sound attributes. The particular sound attribute is associated with a particular audio object of the one or more audio objects. The controller is also configured to modify the audio metadata, based on the indication, to generate modified audio metadata.

According to another implementation of the present disclosure, a method of processing an encoded audio signal includes receiving an audio bitstream. The audio bitstream includes encoded audio associated with one or more audio objects and audio metadata indicating one or more sound attributes of the one or more audio objects. The method also includes storing the encoded audio and the audio metadata. The method further includes receiving an indication to adjust a particular sound attribute of the one or more sound attributes. The particular sound attribute is associated with a particular audio object of the one or more audio objects. The method also includes modifying the audio metadata, based on the indication, to generate modified audio metadata.

According to another implementation of the present disclosure, a non-transitory computer-readable medium includes instructions for processing an encoded audio signal. The instructions, when executed by a processor, cause the processor to perform operations including receiving an audio bitstream. The audio bitstream includes encoded audio associated with one or more audio objects and audio metadata indicating one or more sound attributes of the one or more audio objects. The operations also include receiving an indication to adjust a particular sound attribute of the one or more sound attributes. The particular sound attribute is associated with a particular audio object of the one or more audio objects. The operations also include modifying the audio metadata, based on the indication, to generate modified audio metadata.

According to another implementation of the present disclosure, an apparatus includes means for receiving an audio bitstream. The audio bitstream includes encoded audio associated with one or more audio objects and audio metadata indicating one or more sound attributes of the one or more audio objects. The apparatus also includes means for storing the encoded audio and the audio metadata. The apparatus also includes means for receiving an indication to adjust a particular sound attribute of the one or more sound attributes. The particular sound attribute is associated with a particular audio object of the one or more audio objects. The apparatus also includes means for modifying the audio metadata, based on the indication, to generate modified audio metadata.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a particular implementation of a system that is operable to perform three-dimensional (3D) audio rendering of audio based on a user input;

FIG. 2 is a particular implementation of an audio scene that is modified for 3D audio rendering based on a user input;

FIG. 3 is a particular implementation of audio metadata that is to be modified for 3D audio rendering based on a user input;

FIGS. 4A-4D depict non-limiting examples of user inputs used to modify audio metadata for 3D audio rendering;

FIG. 5 is a particular implementation of modified metadata based on a user input for 3D audio rendering;

FIG. 6 is a particular implementation of a process diagram for performing 3D audio rendering of audio based on a user input;

FIG. 7 is a particular implementation of an object-based audio process diagram for performing audio rendering of audio based on a user input;

FIGS. 8A-8B depict non-limiting examples of audio scenes modified by a user input;

FIGS. 9A-9B depict non-limiting examples of adjusting an audio level based on a user input;

FIG. 10 is a particular implementation of a scene-based audio process diagram for performing audio rendering of audio based on a user input;

FIG. 11 is a particular implementation of a process diagram for selecting a display device for rendered video based on a user input;

FIGS. 12A-12B depict non-limiting examples of displaying rendered video at different devices based on a user input;

FIG. 13 is a particular implementation of an input processor operable to modify metadata for 3D audio rendering based on a user input;

FIG. 14 is a particular implementation of a process diagram for modifying metadata based on a detected user input;

FIG. 15 is a particular implementation of another process diagram for modifying metadata based on a detected user input;

FIG. 16 is a particular implementation of a gesture processor;

FIG. 17 is a method of performing 3D audio rendering on audio based on a user input;

FIG. 18 is a particular implementation of a system that is operable to modify or generate render-side metadata;

FIG. 19 is a method of processing an audio signal; and

FIG. 20 is a block diagram of a user device operable to perform 3D audio rendering of audio based on a user input.

### V. DETAILED DESCRIPTION

Particular implementations of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Multimedia content may be transmitted in an encoded formatted from a first device to a second device. The first device may include an encoder that encodes the multimedia content, and the second device may include a decoder that decodes the multimedia content prior to rendering the multimedia content for one or more users. To illustrate, the multimedia content may include encoded audio. Different sound-producing objects may be represented in the encoded audio. For example, a first audio object may produce first audio that is encoded into the encoded audio, and a second audio object may produce second audio that is encoded into the encoded audio. The encoded audio may be transmitted to the second device in an audio bitstream. Audio metadata indicating sound attributes (e.g., location, orientation, volume, etc.) of the first audio and the second audio may also be included in the audio bitstream. For example, the metadata may indicate first sound attributes of the first audio and second sound attributes of the second audio.

Upon reception of the audio bitstream, the second device may decode the encoded audio to generate the first audio and the second audio. The second device may also modify the metadata to change the sound attributes of the first audio and the second audio upon rendering. Thus, the metadata may be modified at a rendering stage (as opposed to an authoring stage) to generate modified metadata. According to one implementation, the metadata may be modified based on a sensor input. An audio renderer of the second device may render the first audio based on the modified metadata to produce first rendered audio having first modified sound attributes and may render the second audio based on the modified metadata to produce second rendered audio having second modified sound attributes. The first rendered audio and the second rendered audio may be output (e.g., played) by an output device. For example, the first rendered audio and the second rendered audio may be output by a virtual reality headset, an augmented reality headset, a mixed reality headset, sound bars, one or more speakers, headphones, a mobile device, a motor vehicle, a wearable device, etc.

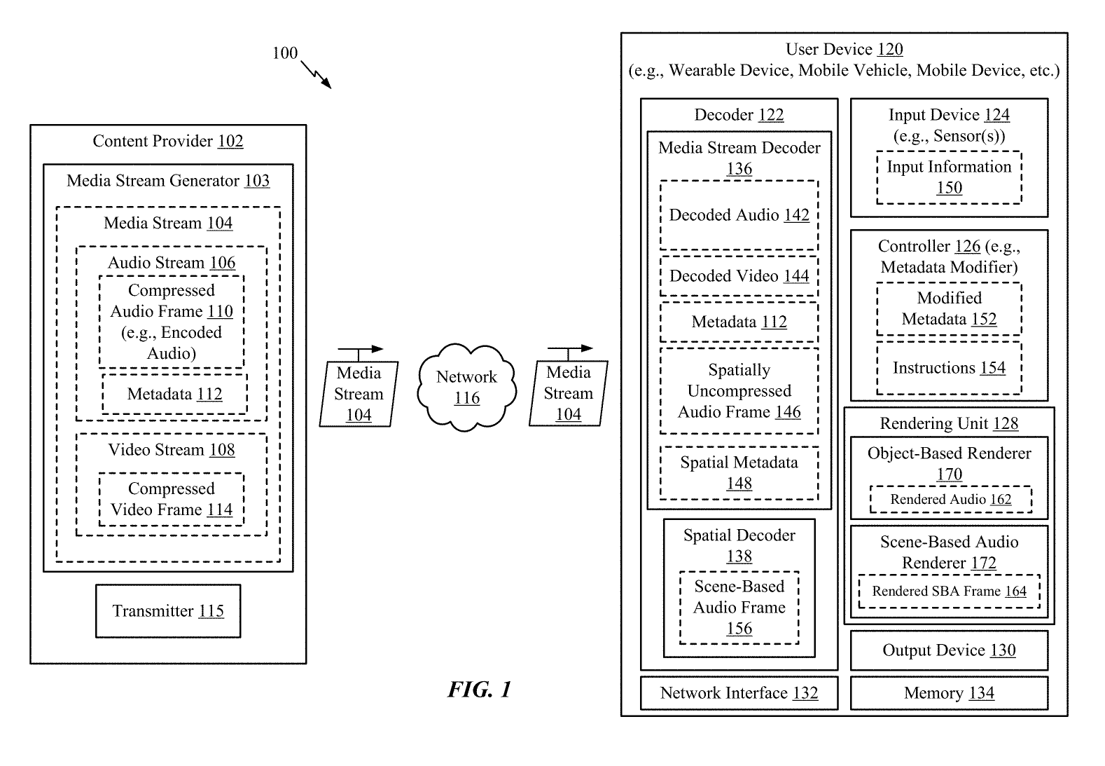

Referring to FIG. 1, a system 100 that is operable to render three-dimensional (3D) audio based on a user input is shown. The system 100 includes a content provider 102 that is communicatively coupled to a user device 120 via a network 116. According to one implementation, the network 116 may be a wired network that is operable to provide data from the content provider 102 to the user device 120. As a non-limiting example, the network 116 may be implemented using a coaxial cable that communicatively couples the content provider 102 and the user device 120. According to another implementation, the network 116 may be a wireless network that is operable to provide data from the content provider 102 to the user device 120. As a non-limiting example, the network 116 may be an Institute of Electrical and Electronics Engineers (IEEE) 802.11 network.

The content provider 102 includes a media stream generator 103 and a transmitter 115. The content provider 102 may be configured to provide media content to the user device 120 via the network 116. For example, the media stream generator 103 may be configured to generate a media stream 104 (e.g., an encoded bit stream) that is provided to the user device 120 via the network 116. According to one implementation, the media stream 104 includes an audio stream 106 and a video stream 108. For example, the media stream generator 103 may combine the audio stream 106 and the video stream 108 to generate the media stream 104.

According to another implementation, the media stream 104 may be an audio-based media stream. For example, the media stream 104 may include only the audio stream 106, and the transmitter 115 may transmit the audio stream 106 to the user device 120. According to yet another implementation, the media stream 104 may be a video-based media stream. For example, the media stream 104 may include only the video stream 108, and the transmitter 115 may transmit the video stream 108 to the user device 120. It should be noted that the techniques described herein may be applied to audio-based media streams, video-based media streams, or a combination thereof (e.g., media streams including audio and video).

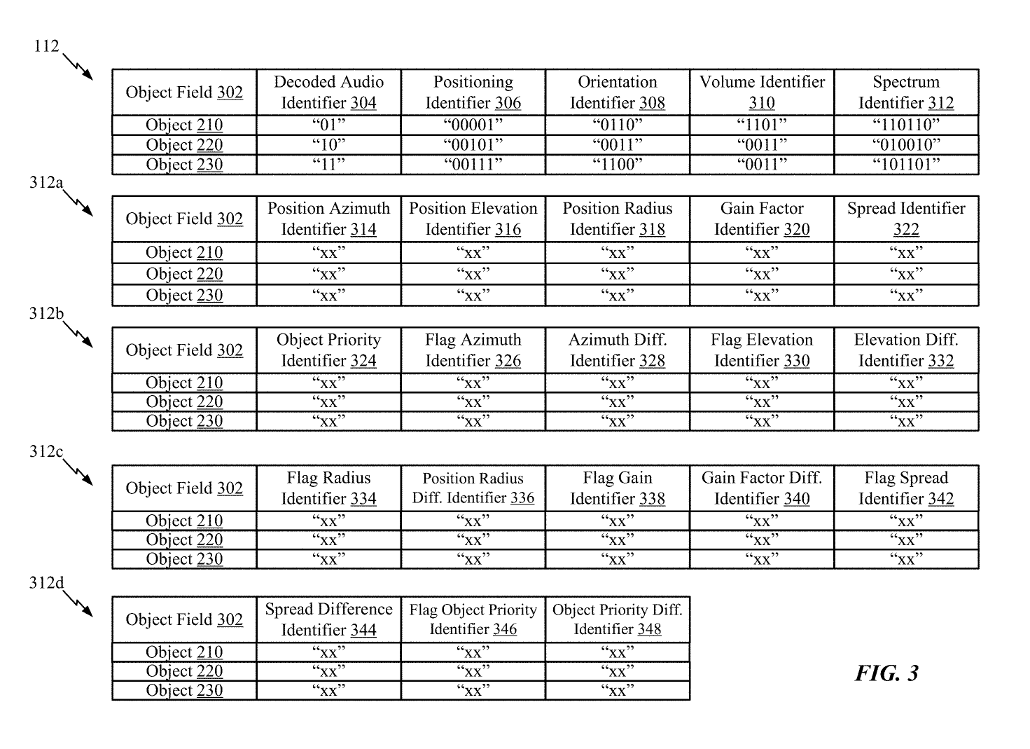

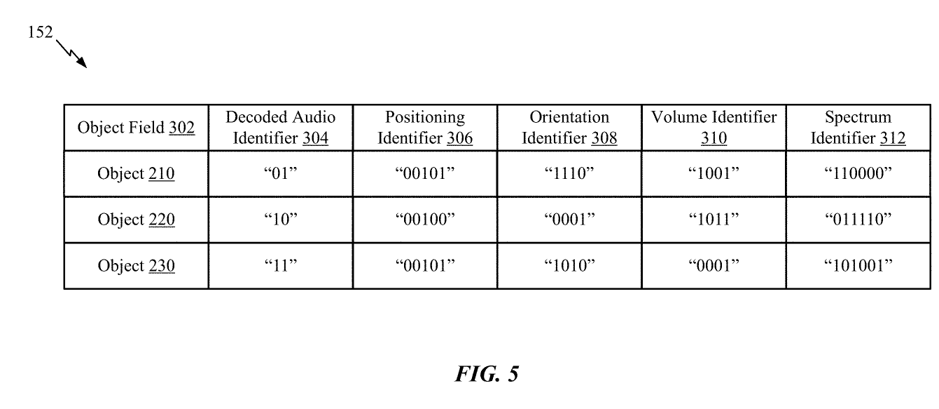

The audio stream 106 may include a plurality of compressed audio frames and metadata corresponding to each compressed audio frame. To illustrate, the audio stream 106 includes a compressed audio frame 110 (e.g., encoded audio) and metadata 112 corresponding to the compressed audio frame 110. The compressed audio frame 110 may be one frame of the plurality of compressed audio frames in the audio stream 106. The metadata 112 includes binary data that is indicative of characteristics of sound-producing objects associated with decoded audio in the compressed audio frame 110, as further described with respect to FIGS. 3 and 5. According to one implementation, the metadata 112 may be object-based metadata. For example, the metadata 112 may include binary data for characteristics of each sound-producing object (or a plurality of sound-producing objects) in an audio environment represented by the compressed audio frame 110. According to another implementation, the metadata 112 may be scene-based metadata. For example, the metadata 112 may include binary data for characteristics of the audio environment, as a whole, represented by the compressed audio frame 110.

The video stream 108 may include a plurality of compressed video frames. According to one implementation, each compressed video frame of the plurality of compressed video frames may provide video, upon decompression, for corresponding audio frames of the plurality of compressed audio frames. To illustrate, the video stream 108 includes a compressed video frame 114 that provides video, upon decompression, for the compressed audio frame 110. For example, the compressed video frame 114 may represent a video depiction of the audio environment represented by the compressed audio frame 110.

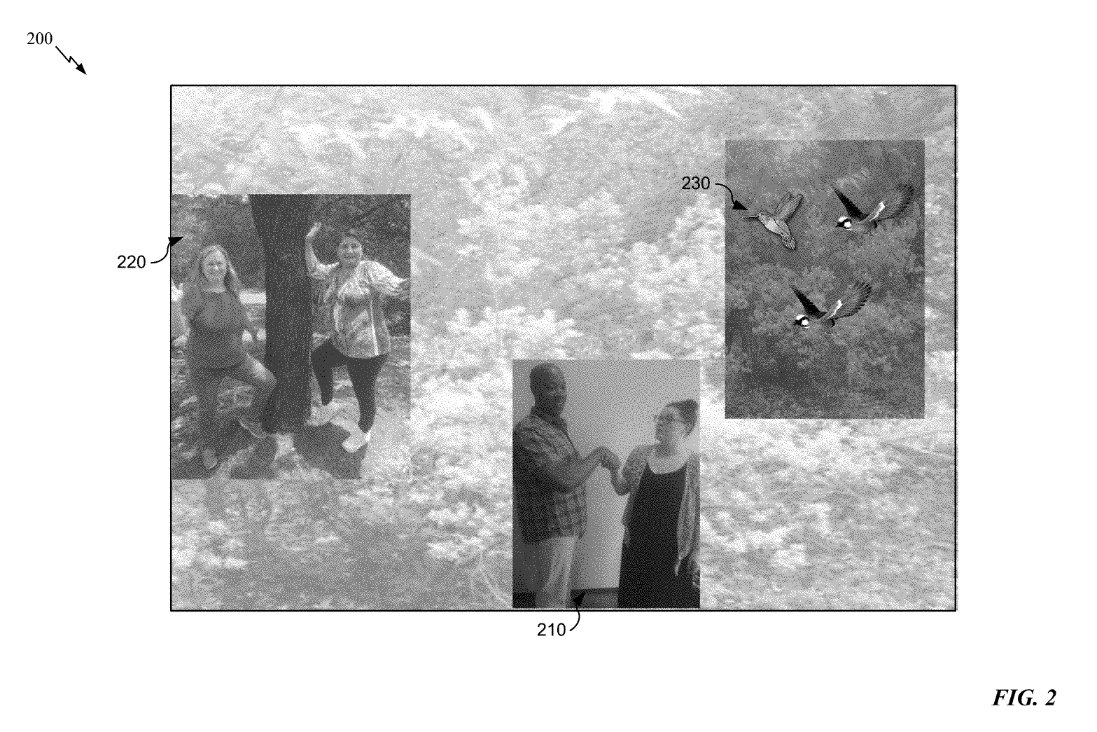

Referring to FIG. 2, an illustrative example of a scene 200 represented by the compressed audio frame 110 and the compressed video frame 114 is shown. For example, the scene 200 may be a video depiction of the audio environment represented by the compressed audio frame 110.

The scene 200 includes multiple sound-producing objects that produce the audio associated with the compressed audio frame 110. For example, the scene 200 includes a first object 210, a second object 220, and a third object 230. The first object 210 may be a foreground object, and the other objects 220, 230 may be background objects. Each object 210, 220, 230 may include different sub-objects. For example, the first object 210 includes a man and a woman. The second object 220 includes two women dancing, two speakers, and a tree. The third object 230 includes a tree and a plurality of birds. It should be understood that the techniques described herein may be implemented using characteristics of each sub-object (e.g., the man, the woman, the speaker, each dancing woman, each bird, etc.); however, for ease of illustration and description, the techniques described herein are implemented using characteristics of each object 210, 220, 230. For example, the metadata 112 may be usable to determine how to spatially pan decoded audio associated with different objects 210, 220, 230, how to adjust the audio level for decoded audio associated with different objects 210, 220, 230, etc.

The metadata 112 may include information associated with each object 210, 220, 230. As a non-limiting example, the metadata 112 may include positioning information (e.g., x-coordinate, y-coordinate, z-coordinate) of each object 210, 220, 230, audio level information associated with each object 210, 220, 230, orientation information associated with each object 210, 220, 230, frequency spectrum information associated with each object 210, 220, 230, etc. It should be understood that the metadata 112 may include alternative or additional information and should not be limited to the information described above. As described below, the metadata 112 may be usable to determine 3D audio rendering information for different encoded portions (e.g., different objects 210, 220, 230) of the compressed audio frame 110.

Referring to FIG. 3, an example of the metadata 112 for each object 210, 220, 230 in the scene 200 is shown. The metadata 112 includes an object field 302, an audio sample identifier 304, a positioning identifier 306, an orientation identifier 308, a level identifier 310, and a spectrum identifier 312. Each field 304-312 may include binary data to identify different audio properties and characteristics of the objects 210, 220, 230.

To illustrate, the decoded audio identifier 304 for the first object 210 is binary number “01”, the positioning identifier 306 of the first object is binary number “00001”, the orientation identifier 308 of the first object 210 is binary number “0110”, the level identifier 310 of the first object 210 is binary number “1101” and the spectrum identifier 312 of the first object 210 is binary number “110110”. The decoded audio identifier 304 for the second object 220 is binary number “10”, the positioning identifier 306 for the second object 220 is binary number “00101”, the orientation identifier 308 for the second object 220 is binary number “0011”, the level identifier 310 for the second object 220 is binary number “0011”, and the spectrum identifier 312 for the second object 220 is binary number “010010”. The decoded audio identifier 304 for the third object 230 is binary number “11”, the positioning identifier 306 for the third object 230 is binary number “00111”, the orientation identifier 308 for the third object 230 is binary number “1100”, the level identifier 310 for the third object 230 is binary number “0011”, and the spectrum identifier 312 for the third object 230 is binary number “101101”. As described with respect to FIG. 1, the metadata 112 may be used by the user device 120 to determine 3D audio rendering information for each object 210, 220, 230.

Although the metadata 112 is shown to include five fields 304-312, in other implementations, the metadata 112 may include additional or fewer fields. FIG. 3 illustrates other implementations of metadata 312a-312d that includes different fields. It should be understood the metadata 112 may include any of the fields included in the metadata 312a-312d, other fields, or a combination thereof.

The metadata 312a includes a position azimuth identifier 314, a position elevation identifier 316, a position radius identifier 318, a gain factor identifier 320, and a spread identifier 322. The metadata 312b includes an object priority identifier 324, a flag azimuth identifier 326, an azimuth difference identifier 328, a flag elevation identifier 330, and an elevation difference identifier 332. The metadata 312c includes a flag radius identifier 334, a position radius difference identifier 336, a flag gain identifier 338, a gain factor difference identifier 340, and a flag spread identifier 342. The metadata 312d includes a spread difference identifier 344, a flag object priority identifier 346, and an object priority difference identifier 348.

Referring back to FIG. 1, the transmitter 115 may transmit the metadata 112 to the user device 120 via the network 116. The user device 120 may be any device that is operable to receive an encoded media stream, decode the encoded media stream, and perform rendering operations on the decoded media stream. Non-limiting examples of the user device 120 may include a mobile phone, a laptop, a set-top box, a tablet, a personal digital assistant (PDA), a computer, a home entertainment system, a television, a smart device, etc. According to some implementations, the user device 120 may include a wearable device (e.g., a virtual reality headset, an augmented reality headset, a mixed reality headset, headphones, a watch, a belt, jewelry, etc.), a mobile vehicle, a mobile device, etc. The user device 120 includes a decoder 122, an input device 124, a controller 126, a rendering unit 128, an output device 130, a network interface 132, and a memory 134. According to one implementation, the input device 124 is integrated into the output device 130. Although not shown, the user device 120 may include one or more additional components. Additionally, one or more of the components 122-134 in the user device 120 may be integrated into a single component.

The network interface 132 may be configured to receive the media stream 104 from the content provider 102. Upon reception of the media stream 104, the decoder 122 of the user device 120 may extract different components of the media stream 104. For example, the decoder 122 includes a media stream decoder 136 and a spatial decoder 138. The media stream decoder 136 may be configured to decode the encoded audio (e.g., the compressed audio frame 110) to generate decoded audio 142, decode the compressed video frame 114 to generate decoded video 144, and extract the metadata 112 of the media stream 104. According to a scene-based audio implementation, the media stream decoder 136 may be configured to generate an audio frame 146, such as a spatially uncompressed audio frame, from the compressed audio frame 110 of the media stream 104 and configured to generate spatial metadata 148 from the media stream 104. The audio frame 146 may include spatially uncompressed audio, such as higher order ambisonics (HOA) audio signals that are not processed by spatial compression.

To enhance user experience, the metadata 112 (or the spatial metadata 148) may be modified based on one or more user inputs. For example, the input device 124 may detect one or more user inputs. According to one implementation, the input device 124 may include a sensor to detect movements (or gestures) of a user. As a non-limiting example, the input device 124 may detect a location of the user, a head orientation of the user, an eye gaze of a user, hand gestures, body movements of the user, etc. According to some implementations, the sensor (e.g., the input device 124) may be attached to a wearable device (e.g., the user device 120) or integrated into the wearable device. The wearable device may include a virtual reality headset, an augmented reality headset, a mixed reality headset, or headphones.

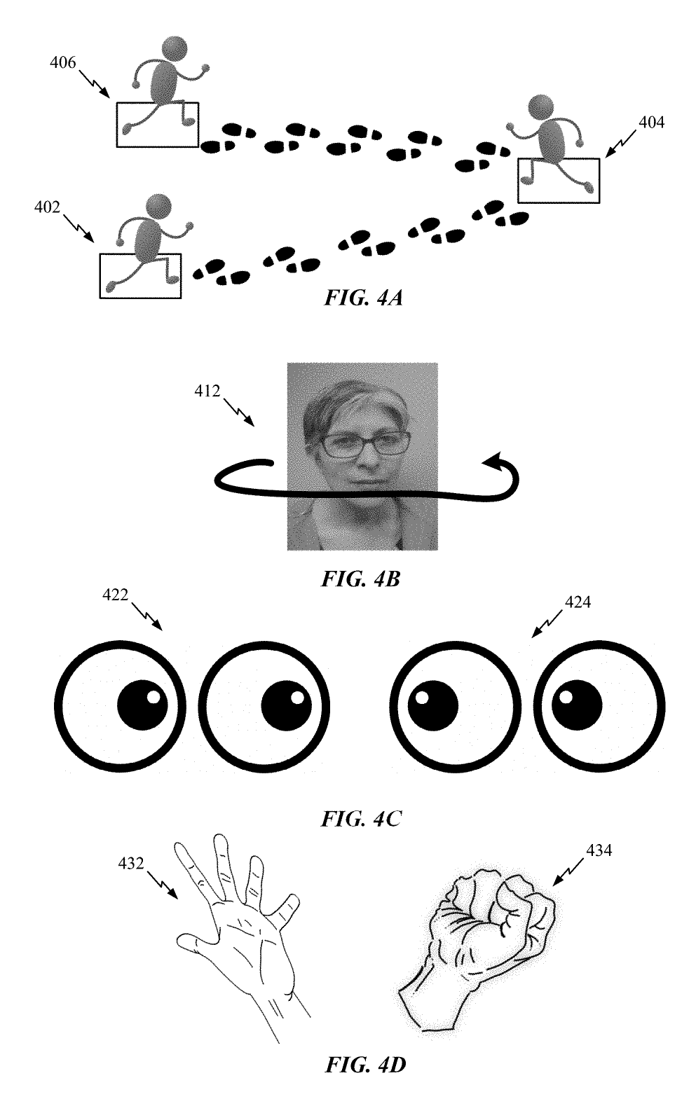

Referring to FIGS. 4A-4D, non-limiting examples of user inputs detected by a sensor (e.g., the input device 124) are shown. FIG. 4A illustrates detection of a user location. For example, the input device 124 may detect whether the user is at a first location 402, a second location 404, a third location 406, etc. FIG. 4B illustrates detection of a head orientation of a user. For example the input device 124 may detect whether a head orientation 412 of the user is facing north, east, south, west, northeast, northwest, southwest, southeast, etc. FIG. 4C illustrates detection of an eye gaze of a user. For example, the input device 124 may detect whether the user's eyes are looking in a first direction 422, a second direction 424, etc. FIG. 4D illustrates detection of hand gestures. For example, the input device 124 may detect a first hand gesture 432 (e.g., an open hand), a second hand gesture 434 (e.g., a closed fist), etc. It should be understood that the user inputs detected by the input device 124 (e.g., the sensor) in FIGS. 4A-4D are merely for illustrative purposes and should not be construed as limiting. Other user inputs may be detected by the input device 124, including typographical inputs, speech inputs, etc.

Referring back to FIG. 1, the input device 124 may be configured to generate input information 150 indicative of the detected user input. The input information 150 may be an indication to adjust a particular sound attribute of the one or more sound attributes of the objects 210, 220, 230. Unless otherwise noted, the detected user input described herein may correspond to the user moving from the first location 402 to the second location 404. It should be noted that other user inputs (e.g., the other user inputs of FIGS. 4A-4D, typographical inputs, speech inputs, etc.) may be used with the techniques implemented herein and the user moving from the first location 402 to the second location 404 is used solely for ease of description.

The input device 124 may provide the input information 150 to the controller 126. The controller 126 (e.g., a metadata modifier) may be configured to modify the metadata 112 based on the input information 150 indicative of the detected user input. For example, the controller 126 may modify the binary numbers in the metadata 112 based on the user input to generate modified metadata 152. To illustrate, the controller 126 may determine, based on the input information 150 indicating that the user moved from the first location 402 to the second location 404, to change the binary numbers in the metadata 112 so that upon rendering, the user's experience at the second location 404 is enhanced. For example, playback of 3D audio and playback of video may be modified to complement the user based on the detected input, as described below.

Referring to FIG. 5, an example of the modified metadata 152 for each object 210, 220, 230 in the scene 200 is shown. The binary data in the modified metadata 152 may be modified with respect to the binary data in the metadata 112 to reflect the user input. To illustrate, the positioning identifier 306 of the first object 210 is binary number “00101”, the orientation identifier 308 of the first object 210 is binary number “1110”, the level identifier 310 of the first object 210 is binary number “1001”, and the spectrum identifier 312 of the first object 210 is binary number “110000”. The positioning identifier 306 for the second object 220 is binary number “00100”, the orientation identifier 308 for the second object 220 is binary number “0001”, the level identifier 310 for the second object 220 is binary number “1011”, and the spectrum identifier 312 for the second object 220 is binary number “011110”. The positioning identifier 306 for the third object 230 is binary number “00101”, the orientation identifier 308 for the third object 230 is binary number “1010”, the level identifier 310 for the third object 230 is binary number “0001”, and the spectrum identifier 312 for the third object 230 is binary number “101001”.

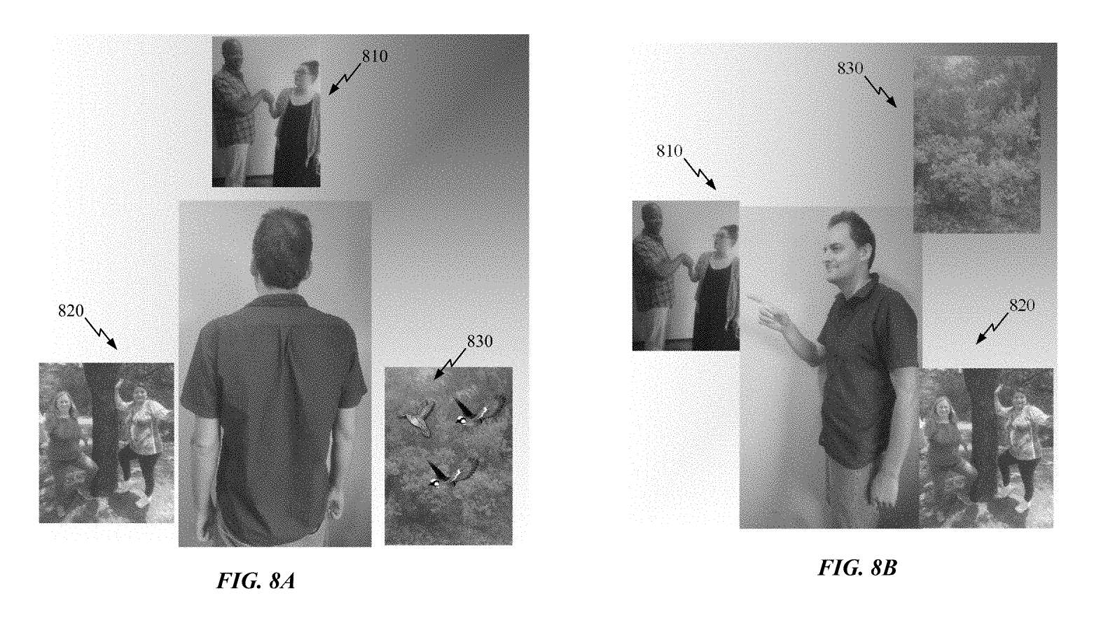

Referring back to FIG. 1, the controller 126 may provide the modified metadata 152 to the rendering unit 128. The rendering unit 128 includes an object-based renderer 170 and a scene-based audio renderer 172. The object-based renderer 170 may be configured to render the decoded audio 142 based on the modified metadata 152 to generate rendered audio 162 having 3D sound attributes. For example, the object-based renderer 170 may spatially pan the different decoded audio 142 according to the modified metadata 152 and may adjust the level for different decoded audio 142 according to the modified metadata 152. Additional detail indicating benefits of modifying the metadata based on the user input (e.g., a user movement, user orientation, or a user gesture) is described with respect to FIGS. 8A, 8B, 9A, 9B, and 12.

According to the scene-based audio implementation, the controller 126 may generate instructions 154 (e.g., codes) that indicate how to modify the spatial metadata 148 based on the input information 150. The spatial decoder 138 may be configured to process the audio frame 146 based on the spatial metadata 148 (modified by the instructions 154) to generate a scene-based audio frame 156. The scene-based audio renderer 172 may be configured to render the scene-based audio frame 156 to generate a rendered scene-based audio frame 164.

The output device 130 may be configured to output the rendered audio 162, the rendered scene-based audio frame 164, or both. According to one implementation, the output device 130 may be an audio-video playback device (e.g., a television, a smartphone, etc.).

According to one implementation, the input device 124 is a standalone device that communicates with another device (e.g., a decoding-rendering device) that includes the decoder 122, the controller 126, the rendering unit 128, the output device 130, and the memory 134. For example, the input device 124 detects the user input (e.g., the gesture) and generates the input information 150 based on the user input. The input device 124 sends the input information 150 to the other device, and the other device modifies the metadata 112 according to the techniques described above.

The techniques described with respect to FIGS. 1-5 may enable 3D audio to be modified based on one or more user inputs to enhance a user experience. For example, the user device 120 may modify the metadata 112 associated with different sound-producing objects 210, 220, 230 based on the user inputs so that upon rendering, decoded audio associated with the sound-producing objects 210, 220, 230 may be adjusted to enhance the user experience. One non-limiting example of modifying the metadata 112 includes be adjusting properties of the decoded audio 142 so, upon rendering, the audio output by the output device 130 has a sweet spot that follows the location of the user. Another non-limiting example of modifying the metadata 112 includes adjusting a level of the decoded audio 142 or a portion of the decoded audio 142 associated with an object 210, 220, or 230 based on a user hand gesture so, upon rendering, the audio output by the output device 130 has a level controlled by the user hand gesture. To illustrate, if the user makes the first hand gesture 432, the level may increase. However, if the user makes the second hand gesture 434, the level may decrease.

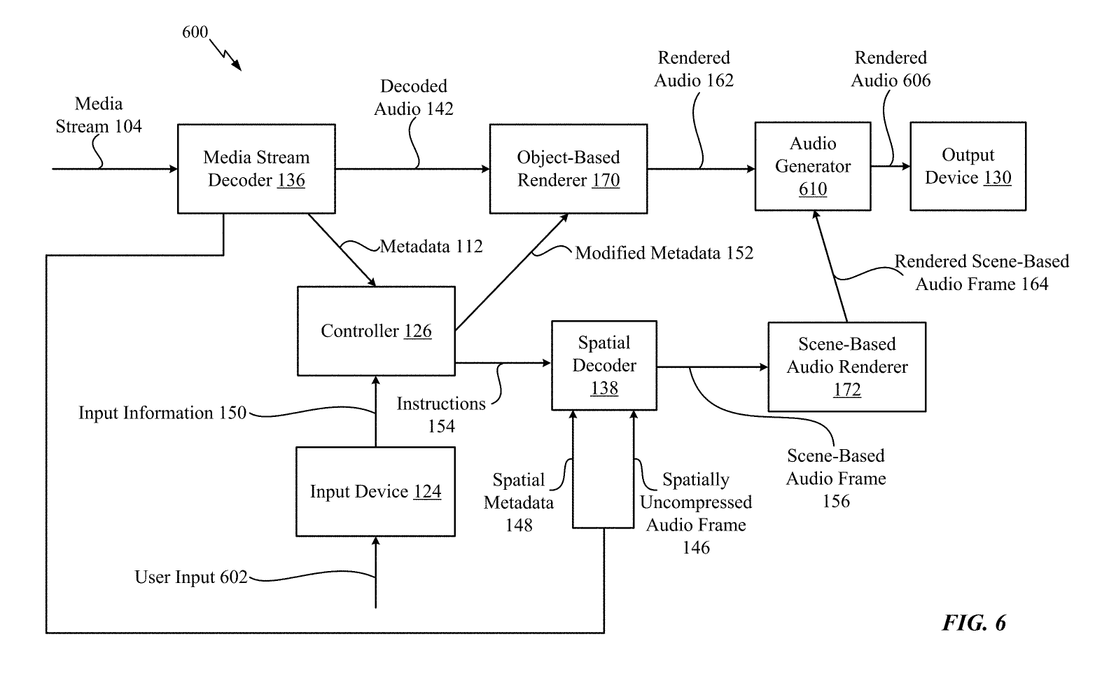

Referring to FIG. 6, a process diagram 600 for rendering 3D audio based on a user input is shown. The process diagram 600 includes the media stream decoder 136, the input device 124, the spatial decoder 138, the controller 126, the object-based renderer 170, the scene-based audio renderer 172, an audio generator 610, and the output device 130. According to one implementation, the input device 124 may be a gesture sensor and the output device 130 may include one or more sound bars, headphones, speakers, etc.

The media stream decoder 136 may decode the media stream 104 to generate the decoded audio 142, the metadata 112 associated with the decoded audio 142, the spatial metadata 148, and the spatially compressed audio frame 146. The metadata 112 may be usable to determine 3D audio rendering information for different sound-producing objects (e.g., the objects 210, 220, 230) associated with sounds of the decoded audio 142. The metadata 112 is provided to the controller 126, the decoded audio 142 is provided to the object-based renderer 170, the spatial metadata 148 is provided to the spatial decoder 138, and the spatially uncompressed audio frame 146 is also provided to the spatial decoder 138.

The input device 124 may detect a user input 602 and generate the input information 150 based on the user input 602. As a non-limiting example, the input device 124 may detect one of the user inputs described with respect to FIGS. 4A-4D, a typographical user input, a speech user input, or another user input. For ease of description, the user input 602 may correspond to the user turning his or her head (e.g., a change in the user's head orientation). However, it should be understood that this is merely a non-limiting illustrative example of the user input 602. The controller 126 may modify the metadata 112 based on the input information 150 associated with the user input 602 (e.g., the gesture) to generate the modified metadata 152.

Thus, the controller 126 may adjust the metadata 112 to generate the modified metadata 152 to account for the change in the user's head orientation. The modified metadata 152 is provided to the object-based renderer 170. The object-based renderer 170 may render the decoded audio 142 based on the modified metadata 152 to generate the rendered audio 162 having 3D sound attributes. For example, the object-based renderer 170 may spatially pan the decoded audio 142 according to the modified metadata 152 and may adjust the level for the decoded audio 142 according to the modified metadata 152.

The controller 126 may also generate the instructions 154 that are used to modify the spatial metadata 148. The spatial decoder 138 may process the audio frame 146 based on the spatial metadata 148 (modified by the instructions 154) to generate the scene-based audio frame 156. The scene-based audio renderer 172 may render the scene-based audio frame 156 to generate the rendered scene-based audio frame 164 having 3D sound attributes.

The audio generator 610 may combine the rendered audio 162 and the rendered scene-based audio frame 164 to generate rendered audio 606, and the rendered audio 606 may be output at the output device 130.

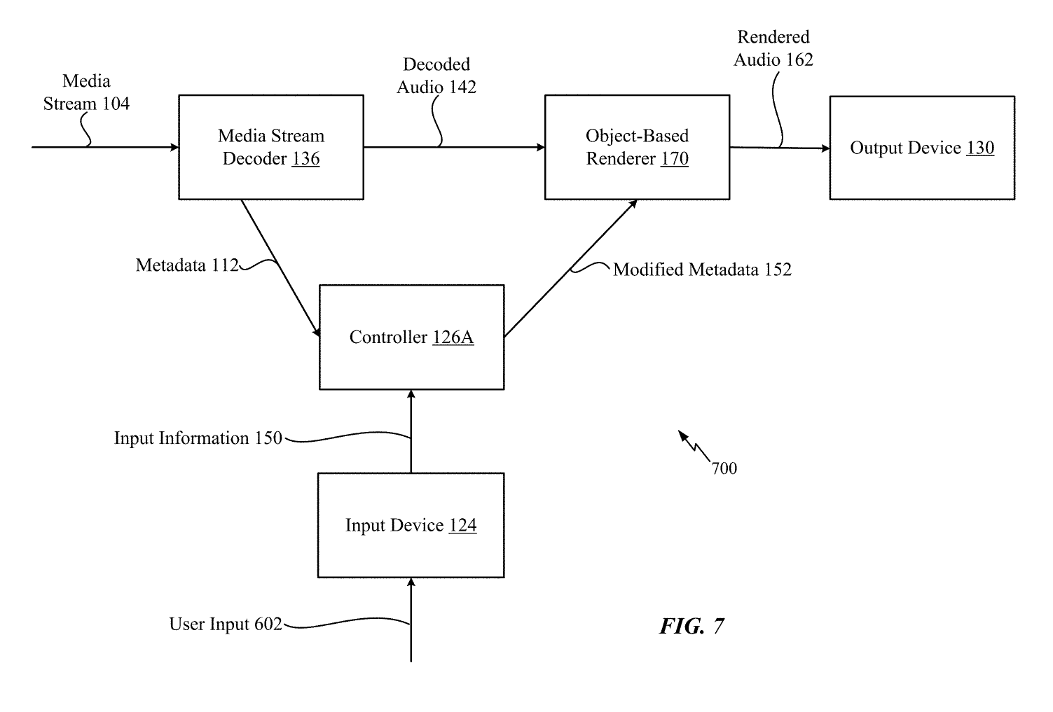

Referring to FIG. 7, another process diagram 700 for rendering 3D audio based on a user input is shown. The process diagram 700 includes the media stream decoder 136, the input device 124, a controller 126A, the object-based renderer 170, and the output device 130. The controller 126A may correspond to an implementation of the controller 126 of FIG. 1. According to one implementation, the input device 124 may be a gesture sensor and the output device 130 may include one or more sound bars, headphones, speakers, etc.

The media stream decoder 136 may decode the media stream 104 to generate the decoded audio 142 and the metadata 112 associated with the decoded audio 142. The metadata 112 may be usable to determine 3D audio rendering information for different sound-producing objects (e.g., the objects 210, 220, 230) associated with sounds of the decoded audio 142. As a non-limiting example, if the decoded audio 142 includes the conversation associated with the first object 210, the music associated with the second object 220, and the bird sounds associated with the third object 230, the metadata 112 may include positioning information for each object 210, 220, 230, level information associated with each object 210, 220, 230, orientation information of each object 210, 220, 230, frequency spectrum information associated with each object 210, 220, 230, etc.

If the metadata 112 is provided to the object-based renderer 170, the object-based renderer 170 may render the decoded audio 142 such that the conversation associated with the first object 210 is output at a position in front of the user at a relatively loud volume, the music associated with the second object 220 is output at a position behind the user at a relatively low volume, and the bird sounds associated with the third object 230 are behind the user at a relatively low volume. For example, referring to FIG. 8A, a first sound 810 associated with the first object 210 may be projected in front of the user, a second sound 820 associated with the second object 220 may projected behind the left shoulder of the user, and a third sound 830 associated with the third object 230 may be projected behind the right shoulder of the user.

To adjust the way the sounds are projected in the event of the user rotating his body (e.g., in the event of the user input 602), the metadata 112 may be modified to adjust how the decoded audio 142 are rendered. For example, referring back to FIG. 7, the input device 124 may detect the user input 602 (e.g., detect that the user rotated his body to the left) and may generate the input information 150 based on the user input 602. The controller 126A may modify the metadata 112 based on the input information 150 associated with the detected user input 602 to generate the modified metadata 152. Thus, the controller 126A may adjust the metadata 112 to account for the change in the user's orientation.

The modified metadata 152 and the decoded audio 142 may be provided to the object-based renderer 170. The object-based renderer 170 may render the decoded audio 142 based on the modified metadata 152 to generate the rendered audio 162 having 3D sound attributes. For example, the object-based renderer 170 may spatially pan the different decoded audio 142 according to the modified metadata 152 and may adjust the level for different decoded audio 142 according to the modified metadata 152. The output device 130 may output the rendered audio 162.

For example, referring to FIG. 8B, the first sound 810 may be projected at a different location such that the first sound 810 is projected in front of the user when the user rotates his body to the left. Additionally, the second sound 820 may be projected at a different location such that the second sound 820 is projected behind the left shoulder of the user when the user rotates his body to the left, and the third sound 830 may be projected at a different location such that the third sound 830 is projected behind the right shoulder of the user when the user rotates his body to the left. Thus, by modifying the metadata 112 based on the user input 602 (e.g., based on the user body rotation), the sounds surrounding the user may also be modified.

According to one implementation, the input device 124 may detect a location of the user as a user input 602, and the controller 126A may modify the metadata 112 based on the location of the user to generate the modified metadata 152. In this scenario, the object-based renderer 170 may render the decoded audio 142 to generate the rendered audio 162 having 3D sound attributes centered around the location. For example, a sweet spot of the rendered audio 162 (as output by the output device 130) may be projected at the location of the user such that the sweet spot follows the user.

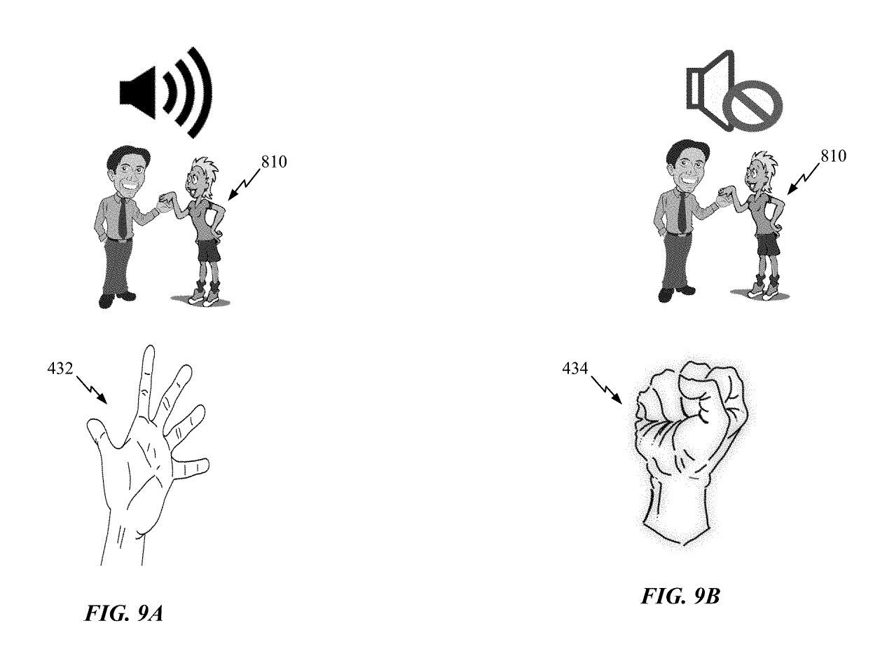

Referring to FIGS. 9A-9B, an example of metadata modification to adjust a level of a particular object is shown. For example, the first hand gesture 432 may be used as the user input 602 to modify the binary number associated with the level identifier 310 of the first object 210. To illustrate, the controller 126A may modify the metadata 112 to increase the level of the first sound 810 when an audio sample of the decoded audio 142 associated with the first sound 810 is rendered by the object-based renderer 170. The second hand gesture 434 may also be used as the user input 602 to modify the binary number associated with the level identifier 310 of the first object 210. To illustrate, the controller 126A may modify the metadata 112 to decrease (or mute) the level of the first sound 810 when the audio sample of the decoded audio 142 associated with the first sound 810 is rendered by the object-based renderer 170.

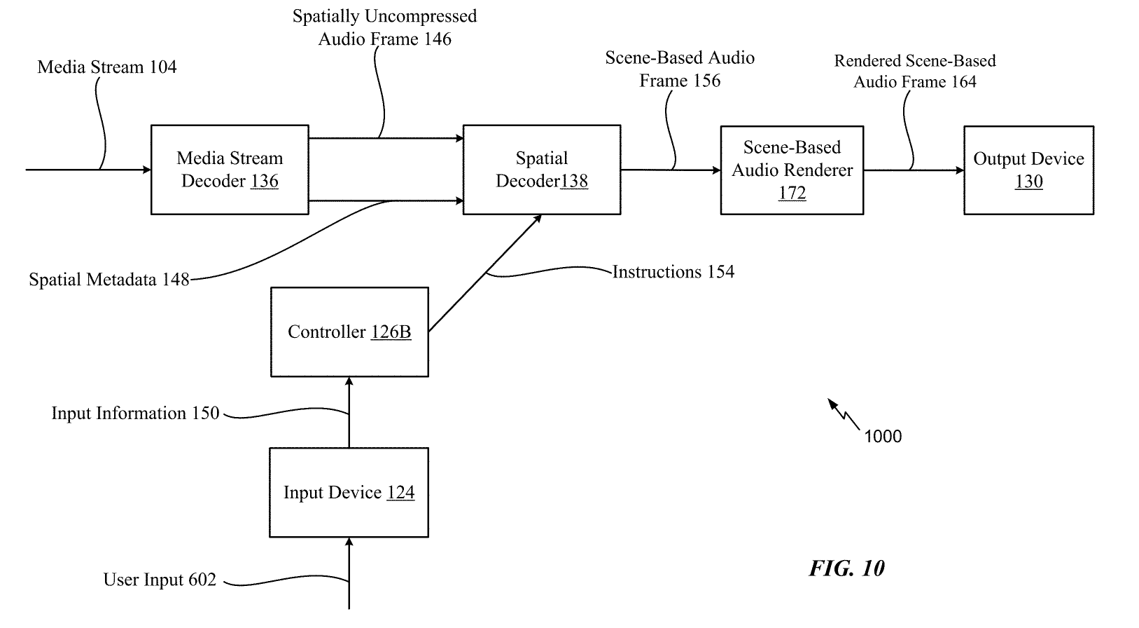

Referring to FIG. 10, another process diagram 1000 for rendering 3D audio based on a user input is shown. The process diagram 1000 includes the media stream decoder 136, the input device 124, a controller 126B, the spatial decoder 138, the scene-based audio renderer 172, and the output device 130. The controller 126B may correspond to an implementation of the controller 126 of FIG. 1.

The media stream decoder 136 may receive the media stream 104 and generate the audio frame 146 and the spatial metadata 148 associated with the audio frame 146. The audio frame 146 and the spatial metadata 148 are provided to the spatial decoder 138.

The input device 124 may detect the user input 602 and generate the input information 150 based on the user input 602. The controller 126B may generate one or more instructions 154 (e.g., codes/commands) based on the input information 150. The instructions 154 may instruct the spatial decoder 138 to modify the spatial metadata 148 (e.g., modify the data of an entire audio scene at once) based on the user input 602. The spatial decoder 138 may be configured to process the audio frame 146 based on the spatial metadata 148 (modified by the instructions 154) to generate the scene-based audio frame 156. The scene-based audio renderer 172 may render the scene-based audio frame 156 to generate the rendered scene-based audio frame 164 having 3D sound attributes. The output device 130 may output the rendered scene-based audio frame 164.

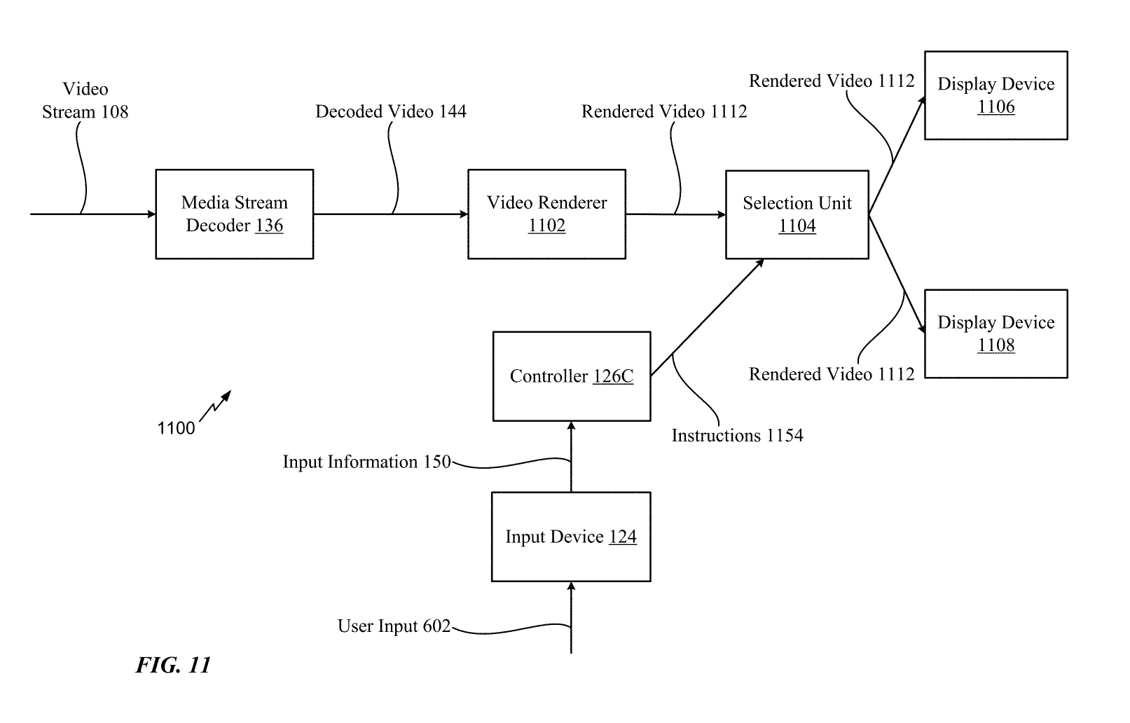

Referring to FIG. 11, a process diagram 1100 for selecting a display device for rendered video is shown. The process diagram 1100 includes the media stream decoder 136, a video renderer 1102, the input device 124, a controller 126C, a selection unit 1104, a display device 1106, and a display device 1108. The controller 126C may correspond to an implementation of the controller 126 of FIG. 1.

The media stream decoder 136 may decode the video stream 108 to generate the decoded video 144, and the video renderer 1102 may render the decoded video 144 to generate rendered video 1112. The rendered video 1112 may be provided to the selection unit 1104.

The input device 124 may detect a location of the user as the user input 602 and may generate the input information 150 indicating the location of the user. For example, the input device 124 may detect whether the user is at the first location 402, the second location 404, or the third location 406. The input device 124 may generate the input information 150 that indicates the user's location. The controller 126C may determine which display device 1106, 1108 is proximate to the user's location and may generate instructions 1154 for the selection unit 1104 based on the determination. The selection unit 1104 may provide the rendered video 1112 to the display device 1106, 1108 that is proximate to the user based on the instructions 1154.

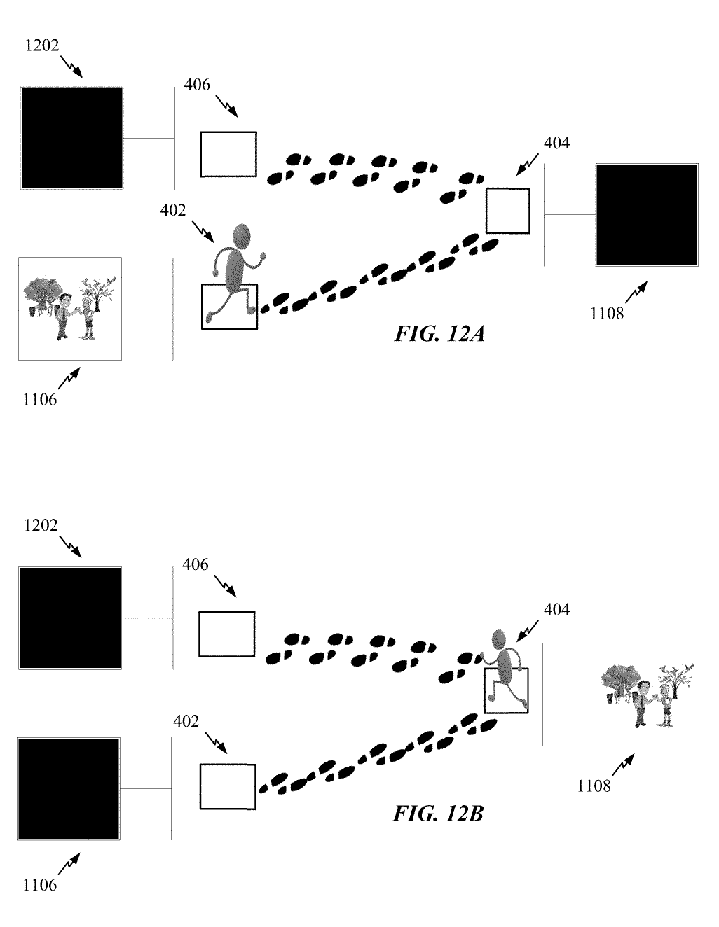

To illustrate, referring to FIGS. 12A-12B, the display device 1106 may be proximate to the first location 402, the display device 1108 may be proximate to the second location 404, and a display device 1202 may be proximate to the third location 406. In FIG. 12A, the controller 126C may determine that the user is at the first location 402. Based on the determination, the selection unit 1104 may display the scene at the display device 1106 (e.g., the display device proximate to the first location 402), and the other display devices 1108, 1202 may be idle. In FIG. 12B, the controller 126C may determine that the user is at the second location 404. Based on the determination, the selection unit 1104 may display the scene at the display device 1108 (e.g., the display device proximate to the second location 404), and the other display devices 1106, 1202 may be idle.

The techniques described with respect to FIGS. 1-12B may enable video playback to be modified and 3D audio to be modified based on one or more user inputs to enhance a user experience. For example, the user device 120 may modify the metadata 112 associated with different sound-producing objects 210, 220, 230 based on the user inputs so that upon rendering, decoded audio associated with the sound-producing objects 210, 220, 230 may be adjusted to enhance the user experience, as illustrated in FIGS. 8A-9B. Additionally, display of video playback may be modified based on a location of a detected user, as illustrated in FIGS. 12A-12B.

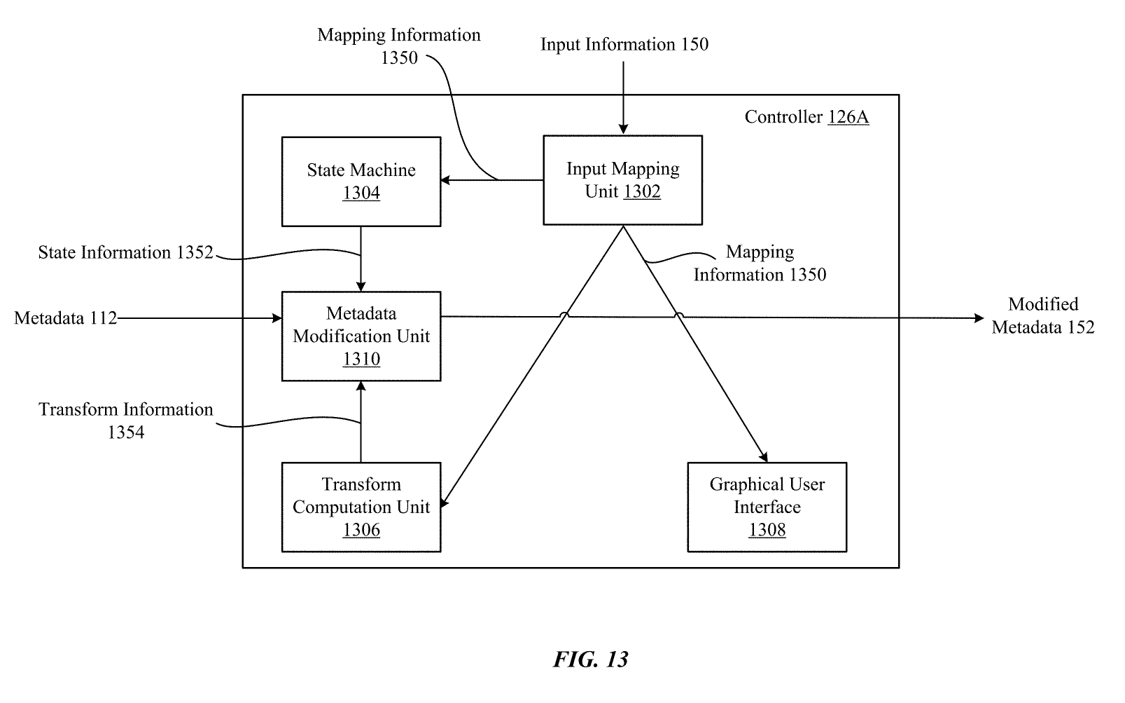

Referring to FIG. 13, a particular example of the controller 126A is shown. The controller 126A includes an input mapping unit 1302, a state machine 1304, a transform computation unit 1306, a graphical user interface 1308, and a metadata modification unit 1310.

The input information 150 may be provided to the input mapping unit 1302. According to one implementation, the input information 150 may undergo a smoothing operation and then may be provided to the input mapping unit 1302. The input mapping unit 1302 may be configured to generate mapping information 1350 based on the input information 150. The mapping information 1350 may map one or more sounds (e.g., one or more sounds 810, 820, 830 associated with the objects 210, 220, 230) to a detected input indicated by the input information 150. As a non-limiting example, the mapping information 1350 may map a hand gesture detected by a user to one or more of the sounds 810, 820, 830. To illustrate, if the user moves his hand to the right, the mapping information 1350 may correspondingly map at least one of the sounds 810, 820, 830 to the right. The mapping information 1350 is provided to the state machine 1304, to the transform computation unit 1306, and to the graphical user interface 1308. According to one implementation, the graphical user interface 1308 may provide a graphical representation of the detected input (e.g., the gesture) to the user based on the mapping information 1350.

The transform computation unit 1306 may be configured to generate transform information 1354 to rotate an audio scene associated with a scene-based audio frame based on the mapping information 1350. For example, the transform information 1354 may indicate how to rotate an audio scene associated with the scene-based audio frame 156 to generate the modified scene-based audio frame 604. The transform information 1354 is provided to the metadata modification unit 1310.

The state machine 1304 may be configured to generate, based on the mapping information 1350, state information 1352 that indicates modifications of different objects 210, 220, 230. For example, the state information 1352 may indicate how characteristics (e.g., locations, orientations, frequencies, etc.) of different objects 210, 220, 230 may be modified based on the mapping information 1350 associated with the detected input. The state information 1352 is provided to the metadata modification unit 1310.

The metadata modification unit 1310 may be configured to modify the metadata 112 to generate the modified metadata 152. For example, the metadata modification unit 1310 may modify the metadata 112 based on the state information 1352 (e.g., object-based audio modification), the transform information 1354 (e.g., scene-based audio modification), or both, to generate the modified metadata 152.

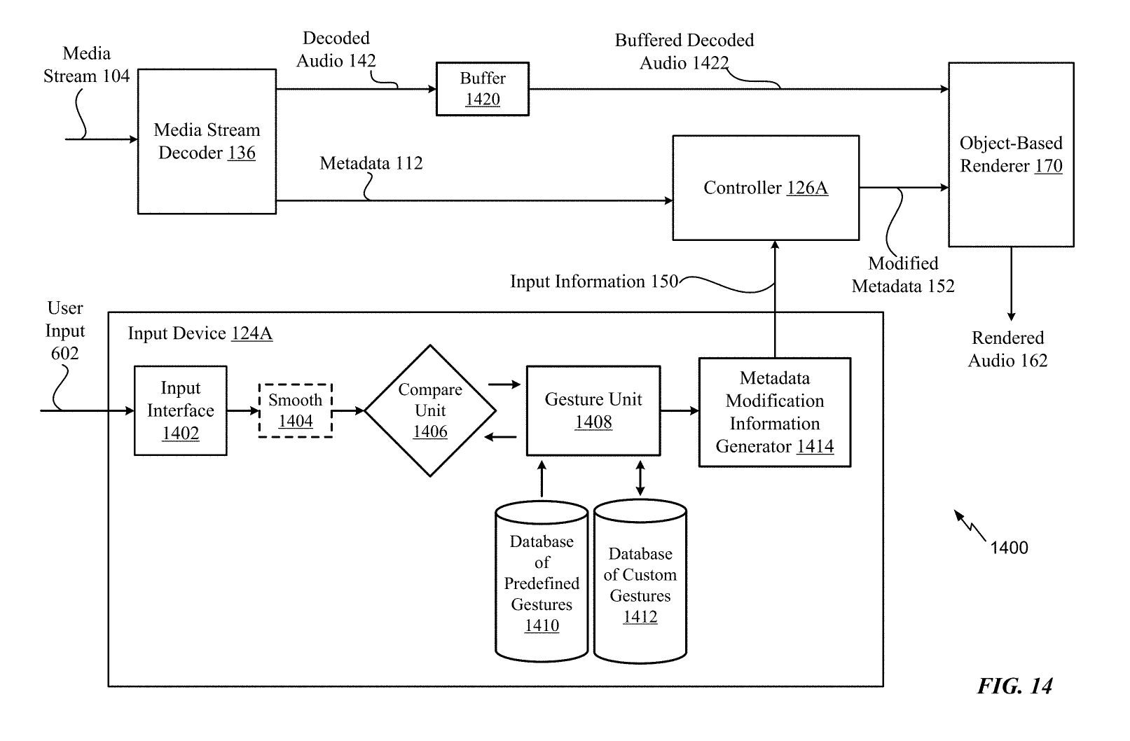

Referring to FIG. 14, a process diagram 1400 for modifying metadata using an object-based renderer is shown. The operations of the process diagram 1400 may be substantially similar to the operations performed by the process diagram 700 of FIG. 7. The process diagram 1400 includes the media stream decoder 136, an input device 124A, the controller 126A, and the object-based renderer 170. The input device 124A may be one implementation of the input device 124 of FIG. 1. According to one implementation, the input device 124A may be a gesture sensor.

The media stream decoder 136 may decode the media stream 104 to generate the decoded audio 142 and the metadata 112 associated with the decoded audio 142. The metadata 112 may be usable to determine 3D audio rendering information for different sound-producing objects (e.g., the objects 210, 220, 230) associated with sounds of the decoded audio 142. As a non-limiting example, if the decoded audio 142 includes the conversation associated with the first object 210, the music associated with the second object 220, and the bird sounds associated with the third object 230, the metadata 112 may include positioning information for each object 210, 220, 230, level information associated with each object 210, 220, 230, orientation information of each object 210, 220, 230, frequency spectrum information associated with each object 210, 220, 230, etc.

If the metadata 112 is provided to the object-based renderer 170, the object-based renderer 170 may render the decoded audio 142 such that the conversation associated with the first object 210 is output at a position in front of the user at a relatively loud volume, the music associated with the second object 220 is output at a position behind the user at a relatively low volume, and the bird sounds associated with the third object 230 are behind the user at a relatively low volume. For example, referring to FIG. 8A, a first sound 810 associated with the first object 210 may be projected in front of the user, a second sound 820 associated with the second object 220 may projected behind the left shoulder of the user, and a third sound 830 associated with the third object 230 may be projected behind the right shoulder of the user. To adjust the way the sounds are projected in the event of the user rotating his body (e.g., in the event of the user input 602), the metadata 112 may be modified to adjust how the decoded audio 142 are rendered.

For example, referring back to FIG. 14, the input device 124A includes an input interface 1402, a compare unit 1406, a gesture unit 1408, a database of predefined gestures 1410, a database of custom gestures 1412, and a metadata modification information generator 1414. The input interface 1402 may detect the user input 602 (e.g., detect that the user rotated his body to the left). According to one implementation, a smoothing unit 1404 smooths the user input 602. The compare unit 1406 may provide the user input 602 to the gesture unit 1408, and the gesture unit 1408 may search the database of predefined gestures 1410 and the database of custom gestures 1412 for a similar gesture to the user input 602.

If the gesture unit 1408 finds a stored gesture (having similar properties to the user input 602) in one of the databases 1410, 1412, the gesture unit 1408 may provide the stored gesture to the compare unit 1406. The compare unit 1406 may compare properties of the stored gesture to properties of the user input 602 to determine whether the user input 602 is substantially similar to the stored gesture. If the compare unit 1406 determines that the stored gesture is substantially similar to the user input 602, the compare unit 1406 instructs the gesture unit 1408 to provide the stored gesture to the metadata modification information generator 1414. The metadata modification information generator 1414 may generate the input information 150 based on the stored gesture. The input information 150 is provided to the controller 126A. The controller 126A may modify the metadata 112 based on the input information 150 associated with the detected user input 602 to generate the modified metadata 152. Thus, the controller 126A may adjust the metadata 112 to account for the change in the user's orientation. The modified metadata 152 is provided to the object-based renderer 170.

A buffer 1420 may buffer the decoded audio 142 to generate buffered decoded audio 1422, and the buffered decoded audio 1422 is provided to the object-based renderer 170. In other implementations, buffering operations may be bypassed and the decoded audio 142 may be provided to the object-based renderer 170. The object-based renderer 170 may render the buffered decoded audio 1422 (or the decoded audio 142) based on the modified metadata 152 to generate the rendered audio 162 having 3D sound attributes. For example, the object-based renderer 170 may spatially pan the different buffered decoded audio 1422 according to the modified metadata 152 and may adjust the level for different buffered decoded audio 1422 according to the modified metadata 152.

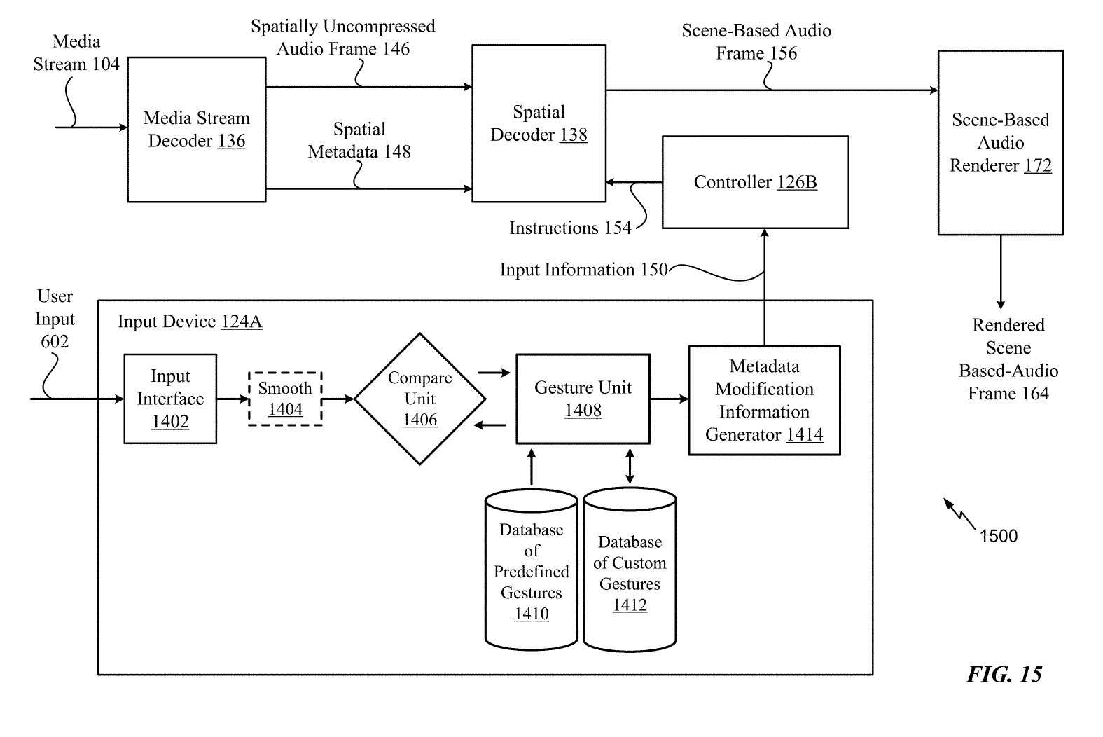

Referring to FIG. 15, a process diagram 1500 for modifying metadata using a scene-based audio renderer is shown. The operations of the process diagram 1500 may be substantially similar to the operations performed by the process diagram 1000 of FIG. 10. The process diagram 1500 includes the media stream decoder 136, the input device 124A, the controller 126B, the spatial decoder 138, and the scene-based audio renderer 172. According to one implementation, the input device 124A may be a gesture sensor.

The input device 124A may operate in a substantially similar manner as described with respect to FIG. 14. For example, the input device 124A may receive a user input 602 and generate input information 150 based on the user input 602, as described with respect to FIG. 14. The input information 150 is provided to the controller 126B.

The media stream decoder 136 may receive the media stream 104 and generate the audio frame 146 and the spatial metadata 148 associated with the audio frame 146. The audio frame 146 and the spatial metadata 148 are provided to the spatial decoder 138. The controller 126B may generate one or more instructions 154 (e.g., codes/commands) based on the input information 150. The instructions 154 may instruct the spatial decoder 138 to modify the spatial metadata 148 (e.g., modify the data of an entire audio scene at once) based on the user input 602. The spatial decoder 138 may be configured to process the audio frame 146 based on the spatial metadata 148 (modified by the instructions 154) to generate the scene-based audio frame 156. The scene-based audio renderer 172 may render the scene-based audio frame 156 to generate the rendered scene-based audio frame 164 having 3D sound attributes.

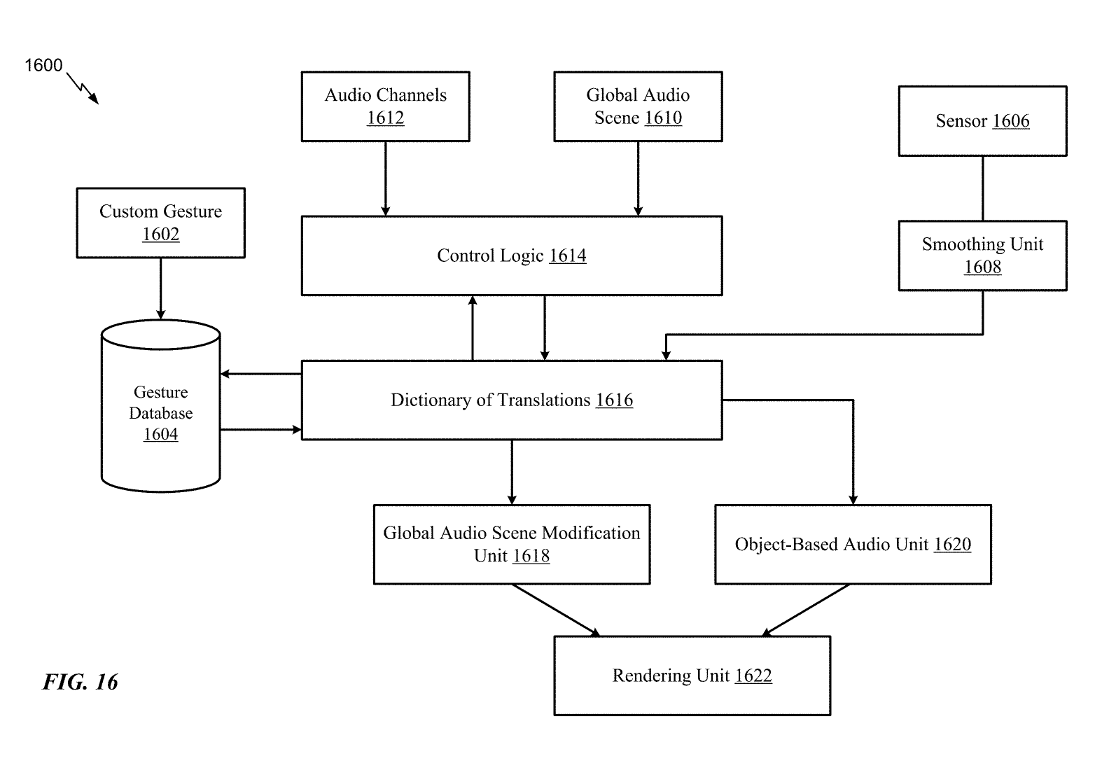

Referring to FIG. 16, a process diagram 1600 of a gesture mapping processor is shown. The operations in the process diagram 1600 may be performed by one or more components of the user device 120 of FIG. 1.

According to the process diagram 1600, a custom gesture 1602 may be added to a gesture database 1604. For example, the user of the user device 120 may add the custom gesture 1602 to the gesture database 1604 to update the gesture database 1604. According to one implementation, the custom gesture 1602 may be one of the user inputs described with respect to FIGS. 4A-4D, another gesture, a typographical input, or another user input. A dictionary of translations 1616 may be accessible to the gesture database 1604.

For object-based audio rendering, one or more audio channels 1612 (e.g., audio channels associated with each object 210, 220, 230) are provided to control logic 1614. For example, the one or more audio channels 1612 may include a first audio channel associated with the first object 210, a second audio channel associated with the second object 220, and a third audio channel associated with the third object 230. For scene-based audio rendering, a global audio scene 1610 is provided to the control logic 1614. The global audio scene 1610 may audibly depict the scene 200 of FIG. 2.

The control logic 1614 may select one or more particular audio channels of the one or more audio channels 1612. As a non-limiting example, the control logic 1614 may select the first audio channel associated with the first object 210. Additionally, the control logic 1614 may select a time marker or a time loop associated with the particular audio channel. As a result, metadata associated with the particular audio channel may be modified at the time marker or during the time loop. The particular audio channel (e.g., the first audio channel) and the time marker may be provided to the dictionary of translations 1616.

A sensor 1606 may detect one or more user inputs (e.g., gestures). For example, the sensor 1606 may detect the user input 602 and provide the detected user input 602 to a smoothing unit 1608. The smoothing unit 1608 may be configured to smooth the detected input 602 and provide the smoothed detected input 602 to the dictionary of translations 1616.

The dictionary of translations 1616 may be configured to determine whether the smoothed detected input 602 corresponds to a gesture in the gesture database 1604. Additionally, the dictionary of translations 1616 may translate data associated with the smoothed detected input 602 into control parameters that are usable to modify metadata (e.g., the metadata 112). The control parameters may be provided to a global audio scene modification unit 1618 and to an object-based audio unit 1620. The global audio scene modification unit 1618 may be configured to modify the global audio scene 1610 based on the control parameters associated with the smoothed detected input 602 to generate a modified global audio scene. The object-based audio unit 1620 may be configured to attach the metadata modified by the control parameters (e.g., the modified metadata 152) to the particular audio channel. A rendering unit 1622 may perform 3D audio rendering on the modified global audio scene, perform 3D audio rendering on the particular audio channel using the modified metadata 152, or a combination thereof, as described above.

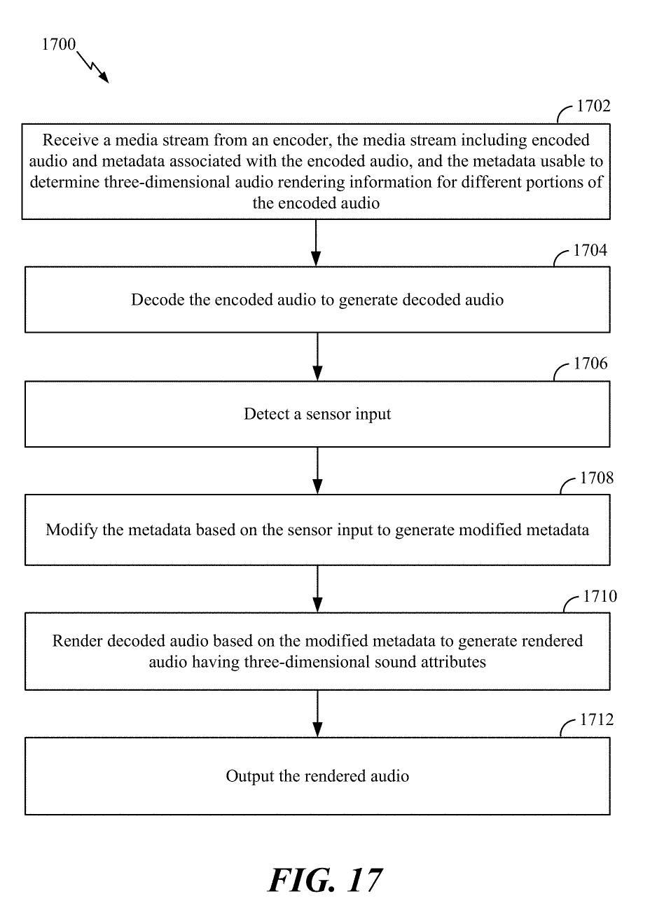

Referring to FIG. 17, a method 1700 of rendering audio is shown. The method 1700 may be performed by the user device 120 of FIG. 1.

The method 1700 includes receiving a media stream from an encoder, at 1702. The media stream may include encoded audio and metadata associated with the encoded audio, and the metadata may be usable to determine three-dimensional audio rendering information for different portions of the encoded audio. For example, referring to FIG. 1, the user device 120 may receive the media stream 104 from the content provider 102. The media stream 104 may include the audio stream 106 (e.g., encoded audio) and the metadata 112 associated with the audio stream 106. The metadata 112 may be usable to determine three-dimensional audio rendering information for different portions of the audio stream 106. For example, the metadata 112 may indicate locations of one or more audio objects, such as the objects 210, 220, 230, associated with the audio stream 106.

The method 1700 also includes decoding the encoded audio to generate decoded audio, at 1704. For example, referring to FIG. 1, the media stream decoder 136 may decode the audio stream 106 (e.g., the compressed audio frame 110) to generate the decoded audio 142.

The method 1700 also includes detecting a sensor input, at 1706. For example, referring to FIG. 1, the input device 124 may detect a sensor input and generate the input information 150 based on the detected sensor input. The detected sensor input may include one of the inputs described with respect to FIGS. 4A-4D or any other sensor input. As non-limiting examples, the sensor input may include a user orientation, a user location, a user gesture, or a combination thereof.

The method 1700 also includes modifying the metadata based on the sensor input to generate modified metadata, at 1708. For example, referring to FIG. 1, the controller 126 may modify the metadata 112 based on the sensor input (e.g., based on the input information 150 indicating characteristics of the sensor input) to generate the modified metadata 152.

The method 1700 also includes rendering decoded audio based on the modified metadata to generate rendered audio having three-dimensional sound attributes, at 1710. For example, referring to FIG. 1, the rendering unit 128 may render the decoded audio (e.g., the decoded audio 142 and/or the audio frame 146) based on the modified metadata 152. To illustrate, for object-based audio rendering, the object-based renderer 170 may render the decoded audio 142 based on the modified metadata 152 to generate the rendered audio 162. For scene-based audio rendering, the scene-based audio renderer 172 may render the audio frame 146 based on the instructions 154 to generate the rendered scene-based audio frame 164.

The method 1700 also includes outputting the rendered audio, at 1712. For example, referring to FIG. 1, the output device 130 may output the rendered audio 162, the rendered scene-based audio frame 164, or both. According to some implementations, the output device 130 may include one or more sound bars, a virtual reality headset, a mixed reality headset, or an augmented reality headset.

According to one implementation of the method 1700, the sensor input may include a user location, and the three-dimensional sound attributes of the rendered audio (e.g., the rendered audio 162) may be centered around the user location. Thus, the output device 130 may output the rendered audio 162 in such a manner that the rendered audio 162 appears to “follow” the user as the user moves. Additionally, according to one implementation of the method 1700, the media stream 104 may include the encoded video (e.g., video stream 108), and the method 1700 may include decoding the encoded video to generate rendered video. For example, the media stream decoder 136 may decode the video stream 108 to generate decoded video 144. The method 1700 may also include rendering the decoded video to generate rendered video and selecting, based on the user location, a particular display device to display the rendered video from a plurality of display devices. For example, the selection unit 1104 may select a particular display device to display the rendered video from a plurality of display devices 1106, 1108, 1202. The method 1700 may also include displaying the rendered video on the particular display device.

According to one implementation, the method 1700 includes detecting a second sensor input. The second sensor input may include audio content from a remote device. For example, the input device 124 may detect the second sensor input (e.g., audio content) from a mobile phone, a radio, a television, or a computer. According to some implementations, the audio content may include an audio advertisement or an audio emergency message. The method 1700 may also include generating additional metadata for the audio content. For example, the controller 126 may generate metadata that indicates a potential location for the audio content to output based on the rendering. The method 1700 may also include rendering audio associated with the audio content to generate second rendered audio having second three-dimensional sound attributes that are different from the three-dimensional sound attributes of the rendered audio 162. For example, the three-dimensional sound attributes of the rendered audio 162 may enable sound reproduction according to a first angular position, and the second three-dimensional sound attributes of the second rendered audio may enable sound reproduction according to a second angular position. The method 1700 may also include outputting the second rendered audio concurrently with the rendered audio 162.

The method 1700 of FIG. 17 may enable 3D audio to be modified based on one or more user inputs to enhance a user experience. For example, the user device 120 may modify the metadata 112 associated with different sound-producing objects 210, 220, 230 based on the user inputs so that upon rendering, decoded audio associated with the sound-producing objects 210, 220, 230 may be adjusted to enhance the user experience. One non-limiting example of modifying the metadata 112 may be adjusting properties of the decoded audio 142 so, upon rendering, the audio output by the output device 130 has a sweet spot that follows the location of the user. Another non-limiting example of modifying the metadata 112 may be adjusting a level of the decoded audio 142 based on a user hand gesture so, upon rendering, the audio output by the output device 130 has a level controlled by the user hand gesture. To illustrate, if the user makes the first hand gesture 432, the level may increase. However, if the user makes the second hand gesture 434, the level may decrease.

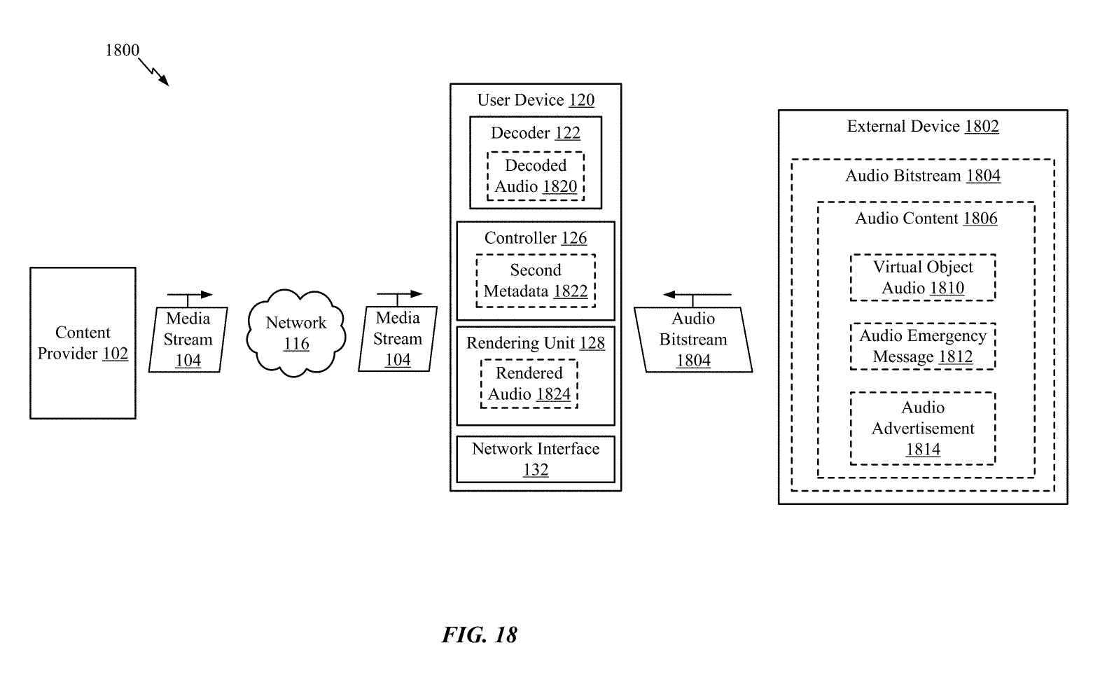

Referring to FIG. 18, a system 1800 that is operable to render 3D audio based on a user input is shown. The system 1800 includes the content provider 102 that is communicatively coupled to the user device 120 via the network 116. The system 1800 also includes an external device 1802 that is communicatively coupled to the user device 120.

The external device 1802 may generate an audio bitstream 1804. The audio bitstream 1804 may include audio content 1806. Non-limiting examples of the audio content 1806 may include virtual object audio 1810 associated with a virtual audio object, an audio emergency message 1812, an audio advertisement 1814, etc. The external device 1802 may transmit the audio bitstream 1804 to the user device 120.

The network interface 132 may be configured to receive the audio bitstream 1804 from the external device 1802. The decoder 122 may be configured to decode the audio content 1806 to generate decoded audio 1820. For example, the decoder 122 may decode the virtual object audio 1810, the audio emergency message 1812, the audio advertisement 1814, or a combination thereof.

The controller 126 may be configured to generate second metadata 1822 (e.g., second audio metadata) associated with the audio bitstream 1804. The second metadata 1822 may indicate one or more locations of the audio content 1806 upon rendering. For example, the rendering unit 128 may render the decoded audio 1820 (e.g., the decoded audio content 1806) to generate rendered audio 1824 having sound attributes based on the second metadata 1822. As a non-limiting example, the virtual object audio 1810 associated with the virtual audio object (or the other audio content 1806) may be inserted in a different spatial location than the other objects 210, 220, 230.

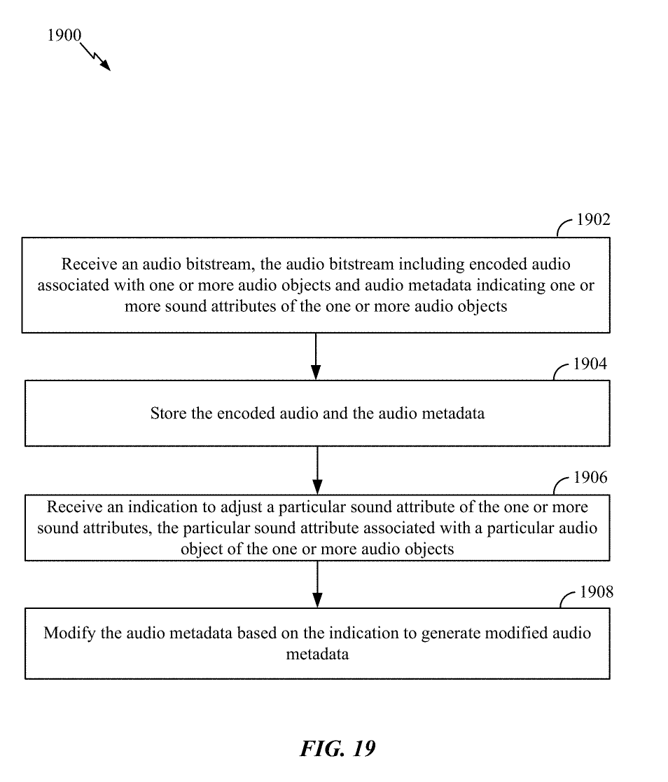

Referring to FIG. 19, a method 1900 of processing an audio signal is shown. The method 1900 may be performed by the user device 120 of FIGS. 1 and 18.

The method 1900 includes receiving an audio bitstream, at 1902. The audio bitstream may include encoded audio associated with one or more audio objects. The audio bitstream may also include audio metadata indicating one or more sound attributes of the one or more audio objects. For example, referring to FIG. 1, the network interface 132 may receive the media stream 104 from the content provider 102. The media stream 104 may include the audio stream 106 (e.g., the audio bitstream) and the video stream 108. The audio stream 106 may include the compressed audio frame 110 (e.g., encoded audio) associated with the objects 210, 220, 230 (e.g., one or more audio objects). The audio stream 106 may also include the metadata 112 (e.g., audio metadata) indicating one or more sound attributes of the objects 210, 220, 230. The one or more sound attributes may include spatial attributes, location attributes, sonic attributes, or a combination thereof.

The method 1900 also includes storing the encoded audio and the audio metadata, at 1904. For example, referring to FIG. 1, the memory 134 may store the compressed audio frame 110 (e.g., the encoded audio) and the metadata 112 (e.g., the audio metadata). According to one implementation, the method 1900 may include decoding the encoded audio to generate decoded audio. For example, the media stream decoder 136 may decode the compressed audio frame 110 (e.g., the encoded audio) to generate the decoded audio 142.

The method 1900 also includes receiving an indication to adjust a particular sound attribute of the one or more sound attributes, at 1906. The particular sound attribute may be associated with a particular audio object of the one or more audio objects. For example, referring to FIG. 1, the controller 126 may receive the input information 150. The input information 150 may be an indication to adjust a particular sound attribute of the one or more sound attributes of the objects 210, 220, 230. According to one implementation, the network interface 132 may receive the input information 150 (e.g., the indication) from an external device that is accessible to the audio bitstream 104. For example, the network interface 132 may receive the input information 150 from the content provider 102,

According to some implementations, the method 1900 includes detecting a sensor movement, a sensor location, or both. The method 1900 may also include generating the indication to adjust the particular sound attribute based on the detected sensor movement, the detected sensor location, or both. For example, referring to FIG. 1, the input device 124 may detect sensor movement, a sensor location, or both. The input device 124 may generate the input information 150 (e.g., the indication to adjust the particular sound attribute) based on the detected sensor movement, the detected sensor location, or both. According to some implementations, the method 1900 includes selecting an identifier associated with a target device, such as an identifier corresponding to a selection of a display by the selection unit 1104 of FIG. 11. The identifier may be based on the sensor movement, the sensor location, or both. The network interface 132 may transmit the identifier to the target device. The target device may include a display device or a video device. According to some implementations, the target device may be integrated into a motor vehicle. According to other implementations, the target device may be a standalone device.

The method 1900 also includes modifying the audio metadata based on the indication to generate modified audio metadata, at 1908. For example, the controller 126 may modify the metadata 112 (e.g., the audio metadata) based on the input information 150 to generate the modified metadata 152 (e.g., the modified audio metadata).

According to one implementation, the method 1900 may include rendering the decoded audio based on the modified audio metadata to generate loudspeaker feeds. For example, the rendering unit 128 (e.g., an audio renderer) may render the decoded audio based on the modified metadata to generate the rendered audio 162. According to one implementation, the rendered audio 162 may include loudspeaker feeds that are played by the output device 130. According to another implementation, the rendered audio 162 may include binauralized audio, and the output device 130 may include at least two loudspeakers that output the binauralized audio.

According to one implementation, the method 1900 includes receiving audio content from an external device. For example, referring to FIG. 18, the network interface 132 may receive the audio bitstream 1804 from the external device 1802. The audio bitstream 1804 may include the audio content 1806. The decoder 122 may decode the audio content 1806 to generate the decoded audio 1820. The method 1900 may also include generating second audio metadata associated with the audio bitstream. For example, referring to FIG. 18, the controller 126 may generate the second metadata 1822 (e.g., the second audio metadata) associated with the audio bitstream 1804.

The techniques described with respect to FIGS. 18-19 may enable metadata associated with encoded audio objects to be modified at rendering. Thus, audio projected to the user at rendering may differ from how the audio is encoded to be projected. Additionally, additional audio content 1806 may be inserted into (e.g., combined with) the audio stream 106 to enhance the user experience. For example, the virtual object audio 1810, the audio emergency message 1812, the audio advertisement 1814, or a combination thereof, may be rendered with the encoded audio from the content provider 102 to enhance the user experience. Spatial properties of the additional audio content 1804 may differ from spatial properties of the audio associated with the content provider 102 to enable the user to decipher the difference.

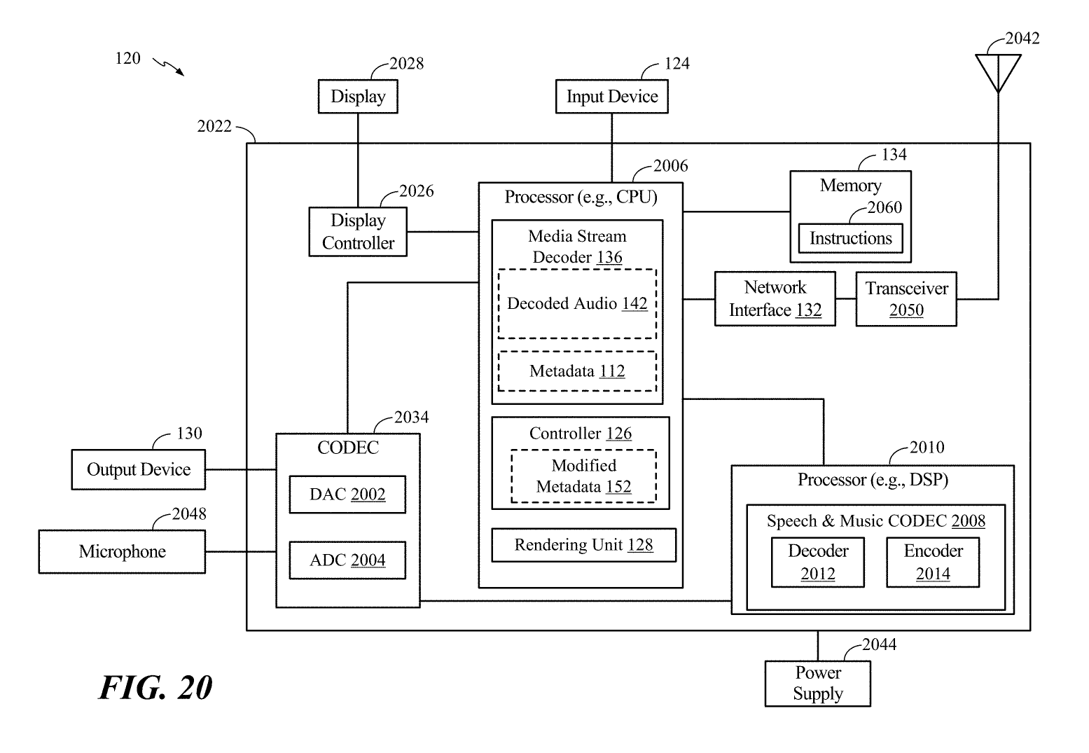

Referring to FIG. 20, a block diagram of the user device 120 is shown. In various implementations, the user device 120 may have more or fewer components than illustrated in FIG. 20.

In a particular implementation, the user device 120 includes a processor 2006, such as a central processing unit (CPU), coupled to the memory 134. The memory 134 includes instructions 2060 (e.g., executable instructions) such as computer-readable instructions or processor-readable instructions. The instructions 2060 may include one or more instructions that are executable by a computer, such as the processor 2006. The user device 120 may include one or more additional processors 2010 (e.g., one or more digital signal processors (DSPs)). The processors 2010 may include a speech and music coder-decoder (CODEC) 2008. The speech and music CODEC 2008 may include a vocoder encoder 2014, a vocoder decoder 2012, or both. In a particular implementation, the speech and music CODEC 2008 may be an enhanced voice services (EVS) CODEC that communicates in accordance with one or more standards or protocols, such as a 3rd Generation Partnership Project (3GPP) EVS protocol.

FIG. 20 also illustrates that the network interface 132, such as a wireless controller, and a transceiver 2050 may be coupled to the processor 2006 and to an antenna 2042, such that wireless data received via the antenna 2042, the transceiver 2050, and the network interface 132 may be provided to the processor 2006 and the processors 2010. For example, the media stream 104 (e.g., the audio stream 106 and the video stream 108) may be provided to the processor 2006 and the processors 2010. In other implementations, a transmitter and a receiver may be coupled to the processor 2006 and to the antenna 2042.

The processor 2006 includes the media stream decoder 136, the controller 126, and the rendering unit 128. The media stream decoder 136 may be configured to decode audio received by the network interface 132 to generate the decoded audio 142. The media stream decoder 136 may also be configured to extract the metadata 112 that indicates one or more sound attributes of the audio objects 210, 220, 230. The controller 126 may be configured to receive an indication to adjust a particular sound attribute of the one or more sound attributes. The controller 126 may also modify the metadata 112 based on the indication to generate the modified metadata 152. The rendering unit 128 may render the decoded audio based on the modified metadata 152 to generate rendered audio.

The device 2000 may include a display controller 2026 that is coupled to the processor 2006 and to a display 2028. A coder/decoder (CODEC) 2034 may also be coupled to the processor 2006 and the processors 2010. The output device 130 (e.g., one or more loudspeakers) and a microphone 2048 may be coupled to the CODEC 2034. The CODEC 2034 may include a DAC 2002 and an ADC 2004. In a particular implementation, the CODEC 2034 may receive analog signals from the microphone 2048, convert the analog signals to digital signals using the ADC 2004, and provide the digital signals to the speech and music CODEC 2008. The speech and music CODEC 2008 may process the digital signals. In a particular implementation, the speech and music CODEC 2008 may provide digital signals to the CODEC 2034. The CODEC 2034 may convert the digital signals to analog signals using the DAC 2002 and may provide the analog signals to the output device 130.

In some implementations, the processor 2006, the processors 2010, the display controller 2026, the memory 2032, the CODEC 2034, the network interface 132, and the transceiver 2050 are included in a system-in-package or system-on-chip device 2022. In some implementations, the input device 124 and a power supply 2044 are coupled to the system-on-chip device 2022. Moreover, in a particular implementation, as illustrated in FIG. 20, the display 2028, the input device 124, the output device 130, the microphone 2048, the antenna 2042, and the power supply 2044 are external to the system-on-chip device 2022. In a particular implementation, each of the display 2028, the input device 124, the output device 130, the microphone 2048, the antenna 2042, and the power supply 2044 may be coupled to a component of the system-on-chip device 2022, such as an interface or a controller.

The user device 120 may include a virtual reality headset, a mixed reality headset, an augmented reality headset, headphones, a headset, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a component of a vehicle, or any combination thereof.

In an illustrative implementation, the memory 134 includes or stores the instructions 2060 (e.g., executable instructions), such as computer-readable instructions or processor-readable instructions. For example, the memory 134 may include or correspond to a non-transitory computer readable medium storing the instructions 2060. The instructions 2060 may include one or more instructions that are executable by a computer, such as the processor 2006 or the processors 2010. The instructions 2060 may cause the processor 2006 or the processors 2010 to perform the method 1700 of FIG. 17, the method 1900 of FIG. 19, or both.

In conjunction with the described implementations, a first apparatus includes means for receiving an audio bitstream. The audio bitstream may include encoded audio associated with one or more audio objects and audio metadata indicating one or more sound attributes of the one or more audio objects. For example, the means for receiving the audio bitstream may include the network interface 130 of FIG. 1, 18, or 20, the transceiver 2050 of FIG. 20, the antenna 2042 of FIG. 20, one or more other structures, circuits, modules, or any combination thereof.

The first apparatus may also include means for storing the encoded audio and the audio metadata. For example, the means for storing may include the memory 134 of FIG. 1 or 20, one or more other structures, circuits, modules, or any combination thereof.

The first apparatus may also include means for receiving an indication to adjust a particular sound attribute of the one or more sound attributes. The particular sound attribute may be associated with a particular audio object of the one or more audio objects. For example, the means for receiving the indication may include the controller 126 of FIG. 1, 6, 7, 10, 11, 13, 18, or 20, one or more other structures, circuits, modules, or any combination thereof.

The first apparatus may also include means for modifying the audio metadata based on the indication to generate modified audio metadata. For example, the means for modifying the audio metadata may include the controller 126 of FIG. 1, 6, 7, 10, 11, 13, 18, or 20, the instructions 2060 executable by one or more of the processors 2006, 2010, one or more other structures, circuits, modules, or any combination thereof.

In conjunction with the described implementations, a second apparatus includes means for receiving a media stream from an encoder. The media stream may include encoded audio and metadata associated with the encoded audio. The metadata may be usable to determine 3D audio rendering information for different portions of the encoded audio. For example, the means for receiving may include the network interface 130 of FIG. 1, 18, or 20, the transceiver 2050 of FIG. 20, the antenna 2042 of FIG. 20, one or more other structures, circuits, modules, or any combination thereof.

The second apparatus may also include means for decoding the encoded audio to generate decoded audio. For example, the means for decoding may include the media stream decoder 136 of FIG. 1, 6, 7, 10, 11, 18, or 20, the instructions 2060 executable by one or more of the processors 2006, 2010, one or more other structures, circuits, modules, or any combination thereof.

The second apparatus may also include means for detecting a sensor input. For example, the means for detecting the sensor input may include the input device 124 of FIG. 1, 6, 7, 10, 11, 18, or 20, one or more other structures, circuits, modules, or any combination thereof.

The second apparatus may also include means for modifying the metadata based on the sensor input to generate modified metadata. For example, the means for modifying the metadata may include the controller 126 of FIG. 1, 6, 7, 10, 11, 13, 18, or 20, the instructions 2060 executable by one or more of the processors 2006, 2010, one or more other structures, circuits, modules, or any combination thereof.

The second apparatus may also include means for rendering the decoded audio based on the modified metadata to generate rendered audio having 3D sound attributes. For example, the means for rendering the decoded audio may include the rendering unit 128 of FIGS. 1, 18, and 20, the object-based renderer 170 of FIG. 1, the scene-based audio renderer 172 of FIG. 1 the instructions 2060 executable by one of the processors 2006, 2010, one or more other structures, circuits, modules, or any combination thereof.

The second apparatus may also include means for outputting the rendered audio. For example, the means for outputting the rendered audio may include the output device 130 of FIG. 1, 6, 7, 10, or 20, one or more other structures, circuits, modules, or any combination thereof.

One or more of the disclosed aspects may be implemented in a system or an apparatus, such as the user device 120, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the user device 120 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, the system or the apparatus may include remote units, such as hand-held personal communication systems (PCS) units, portable data units such as global positioning system (GPS) enabled devices, meter reading equipment, a virtual reality headset, a mixed reality headset, an augmented reality headset, sound bars, headphones, or any other device that includes a processor or that stores or retrieves data or computer instructions, or any combination thereof.

A base station may be part of a wireless communication system and may be operable to perform the techniques described herein. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the disclosure herein may be implemented directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

1. An apparatus comprising:
a network interface configured to receive an audio bitstream, the audio bitstream comprising:
encoded audio associated with a plurality of audio objects; and
audio metadata indicating one or more sound attributes of the plurality of audio objects;
a memory coupled to the network interface, the memory configured to store the encoded audio and the audio metadata; and
a controller coupled to the network interface, the controller configured to:
receive an indication to adjust a particular sound attribute of the one or more sound attributes, the particular sound attribute associated with a particular audio object of the plurality of audio objects; and
modify the audio metadata based on the indication to generate modified audio metadata.

2. The apparatus of claim 1, wherein the one or more sound attributes includes spatial attributes, location attributes, sonic attributes, or a combination thereof.

3. The apparatus of claim 1, further comprising an audio decoder configured to decode the encoded audio to generate decoded audio.

4. The apparatus of claim 3, further comprising an audio renderer configured to render the decoded audio based on the modified audio metadata to generate loudspeaker feeds.

5. The apparatus of claim 4, wherein the audio renderer comprises an object-based audio renderer or a scene-based audio renderer.

6. The apparatus of claim 1, further comprising an input device coupled to the controller, the input device configured to:
detect a user input; and
generate the indication to adjust the particular sound attribute based on the detected user input.

7. The apparatus of claim 6, wherein the input device comprises a sensor that is attached to a wearable device or integrated into the wearable device, and wherein the detected user input corresponds to a detected sensor movement, a detected sensor location, or both.

8. The apparatus of claim 7, wherein the wearable device comprises a virtual reality headset, an augmented reality headset, a mixed reality headset, or headphones.

9. The apparatus of claim 6, further comprising:
an audio decoder configured to decode the encoded audio to generate decoded audio;
an audio renderer configured to render the decoded audio based on the modified audio metadata to generate binauralized audio; and
at least two loudspeakers configured to output the binauralized audio.

10. The apparatus of claim 7, further comprising:
a selection unit configured to select an identifier associated with a target device, the identifier selected based on the detected sensor movement, the detected sensor location, or both,
wherein the network interface is further configured to transmit the identifier to the target device.

11. The apparatus of claim 10, wherein the selection unit includes a display selection device or an audio selection device.

12. The apparatus of claim 1, wherein the network interface is further configured to receive the indication from an external device, the external device accessible to the audio bitstream.

13. The apparatus of claim 1, wherein the network interface is configured to receive audio content from an external device, and further comprising an audio renderer configured to render the audio content.

14. The apparatus of claim 13, wherein the audio content is included in the audio bitstream, and further comprising an audio decoder configured to decode the audio bitstream.

15. The apparatus of claim 13, wherein the audio content is included in the audio bitstream, wherein the controller is further configured to generate second audio metadata associated with the audio bitstream, and further comprising an audio decoder configured to decode the audio bitstream based on the second audio metadata.

16. The apparatus of claim 13, wherein the network interface, the memory, the controller, and the audio renderer are integrated into a wearable virtual reality device, a wearable mixed reality device, a headset, or headphones, and wherein the audio content comprises an audio advertisement or an audio emergency message.

17. The apparatus of claim 13, wherein the audio content represents a virtual audio object from the external device, and wherein the controller is further configured to insert the virtual audio object in a different spatial location than the particular audio object.

18. (canceled)

19. The apparatus of claim 1, wherein the controller is further configured to:
receive a second indication to adjust a second particular sound attribute of the one or more sound attributes, the second particular sound attribute associated with a second particular audio object of the plurality of one or more audio objects, wherein the audio metadata is modified based on the indication and the second indication.

20. A method of processing an encoded audio signal, the method comprising:
receiving an audio bitstream, the audio bitstream comprising:
encoded audio associated with a plurality of audio objects; and
audio metadata indicating one or more sound attributes of the plurality of audio objects;
storing the encoded audio and the audio metadata;
receiving an indication to adjust a particular sound attribute of the one or more sound attributes, the particular sound attribute associated with a particular audio object of the plurality of audio objects; and
modifying the audio metadata based on the indication to generate modified audio metadata.

21. The method of claim 20, wherein the one or more sound attributes includes spatial attributes, location attributes, sonic attributes, or a combination thereof.

22. The method of claim 20, further comprising:
decoding the encoded audio to generate decoded audio; and
rendering the decoded audio based on the modified audio metadata to generate loudspeaker feeds.

23. (canceled)

24. The method of claim 20, further comprising:
detecting a sensor movement, a sensor location, or both; and
generating the indication to adjust the particular sound attribute based on the detected sensor movement, the detected sensor location, or both.

25. A non-transitory computer-readable medium comprising instructions for processing an encoded audio signal, the instructions, when executed by a processor, cause the processor to perform operations comprising:
receiving an audio bitstream, the audio bitstream comprising:
encoded audio associated with a plurality of audio objects; and
audio metadata indicating one or more sound attributes of the plurality of audio objects;
receiving an indication to adjust a particular sound attribute of the one or more sound attributes, the particular sound attribute associated with a particular audio object of the plurality of audio objects; and
modifying the audio metadata based on the indication to generate modified audio metadata.

26. (canceled)

27. The non-transitory computer-readable medium of claim 25, wherein the operations further comprise decoding the encoded audio to generate decoded audio.

28. The non-transitory computer-readable medium of claim 25, wherein the operations further comprise:
receiving audio content from an external device, the audio content included in the audio bitstream; and
rendering the audio content.

29. The non-transitory computer-readable medium of claim 28, wherein the operations further comprise:
generating second audio metadata associated with the audio bitstream; and
decoding the audio bitstream based on the second audio metadata.

30. An apparatus comprising:
means for receiving an audio bitstream, the audio bitstream comprising:
encoded audio associated with a plurality of audio objects; and
audio metadata indicating one or more sound attributes of the plurality of audio objects;
means for storing the encoded audio and the audio metadata;
means for receiving an indication to adjust a particular sound attribute of the one or more sound attributes, the particular sound attribute associated with a particular audio object of the plurality of audio objects; and
means for modifying the audio metadata based on the indication to generate modified audio metadata.

31. The method of claim 20, further comprising:
detecting a hand gesture; and
in response to detecting the hand gesture:
increasing a sound level of the particular audio object in response to the hand gesture corresponding to an open fist, wherein increasing the sound level corresponds to adjustment of the particular sound attribute; or
decreasing the sound level of the particular audio object in response to the hand gesture corresponding to a closed fist, wherein decreasing the sound level corresponds to adjustment of the particular sound attribute.

32. The method of claim 20, wherein modifying the audio metadata comprises modifying particular metadata associated with the particular audio object, and wherein the indication is generated based on a user gesture.

33. The method of claim 20, wherein modifying the audio metadata comprises modifying particular metadata associated with the particular audio object, and wherein the indication is generated based on a user head rotation.
